(19) United States
(12) Patent Application Publication
(10) Pub. No.: US 2010/0264032 A1
(43) Pub. Date: Oct. 21, 2010

(54) INDUCED-CHARGE ELECTROKINETICS WITH HIGH-SLIP POLARIZABLE SURFACES

(76) Inventor: Martin Z. Bazant, Lexington, MA (US)

Correspondence Address: Pearl Cohen Zedek Latzer, LLP, 1500 Broadway, 12th Floor, New York, NY, 10036, US

(21) Appl. No.: 12/741,894

(22) PCT Filed: Nov. 5, 2008
(86) PCT No.: PCT/US08/82513

§ 371 Date: May 7, 2010

Related U.S. Application Data
(60) Provisional application No. 60/996,245, filed on Nov. 7, 2007.

(51) Int. Cl. G01N 27/26

(52) U.S. Cl. 204/518; 204/627

(57) ABSTRACT

This invention provides devices and apparatuses comprising the same, for fast pumping and mixing of relatively small volumes of electrolytes and ionic fluids and materials suspended thereby. Such devices utilize nonlinear induced-charge electro-osmosis as a primary mechanism for driving fluid flow. Such devices comprise a polarizable surface, which is incorporated in the electrodes or pumping elements of the devices as well as a material, which promotes hydrodynamic slip at a region proximal thereto, when the device is subjected to non-linear electro-osmotic flow. Examples of such materials are provided. This invention also provides nanoparticles and microparticles incorporating such materials to enhance nonlinear induced-charge electrophoretic motion. Methods of use of the devices and particles of this invention are described.

### GOVERNMENT SUPPORT

This invention was made in whole or in part with U.S. Government support from the Institute for Soldier Nanotechnologies, US Army Research Office, Grant Number DAAD-19-02-D002. The government has certain rights in the invention.

### BACKGROUND OF THE INVENTION

Nonlinear electrokinetic phenomena involve the motion of a fluid or suspended particles in response to an applied electric field, where the motion depends nonlinearly on the field strength (typically as the square, at low voltage). In electrolytes, the fundamental effect is “induced-charge electro-osmosis” (ICEO), the action of an electric field on its own induced-charge in the electrochemical double layer.

ICEO flows around polarizable (dielectric, metallic, or ion conducting) particles have been used to manipulate asymmetric metal particles in microdevices, by “induced-charge electrophoresis” (ICEP). Recent examples include the alignment of bimetallic (silver/gold) rod-like nano-barcode particles for optical reading in microdevices, as well as the manipulation/separation of metallo-dielectric (latex/gold) Janus particles in nano-materials synthesis.

In all of these applications, there are many unique advantages of nonlinear “induced-charge” electrokinetics. In colloids, the ICEP motion of polarizable particles can be much more complicated, and thus useful for separation, alignment, or assembly, compared to classical linear electrophoresis. Similarly, ICEO/ACEO flows in microdevices easily produce tuneable vortices for mixing and steady pumping. A major practical advantage of nonlinear electrokinetics, especially in microfluidics, is the use of AC voltages, which reduce or eliminate Faradaic reactions, and allow larger voltages to be used. The close spacing of electrodes also allows faster flows for a given voltage, than in linear capillary electro-osmosis. The power dissipation is also extremely small, making ICEO attractive for portable or implantable microfluidics.

In some cases, however, the flows generated are not fast enough for efficient pumping or separation. ICEO-based devices have achieved flow rates with mm/sec velocities, but viscous drag away from the pump and the small pressures generated (<100 Pa=0.001 atm) can limit the flow rate in some applications.

In manipulating biological molecules, reagents, markers, and cells by ICEP or pumping biological fluids by ICEO in current devices, another potential limitation is that the salt concentration of the fluid must be relatively low (<10 mM) and smaller than typical physiological values (>100 mM).

There has also been no attempt to drive linear or nonlinear electro-osmotic flows in room-temperature ionic liquids, perhaps due to their much larger viscosities and smaller charge screening lengths than water.

### SUMMARY OF THE INVENTION

The present invention, in some embodiments, makes use of high-slip polarizable (HSP) surfaces in induced-charge electrokinetic applications for the generation of rapid electroosmotic flows and enhanced electrophoretic mobility.

Hydrodynamic slip length b, in some embodiments, is defined by the fluid mechanical boundary condition, \vec{u}ₛ=b(\hat{n}·∇)\vec{u}, which relates the fluid velocity at a surface (the “hydrodynamic slip”) to the normal derivative of the fluid velocity in the direction of the liquid, or the local shear rate on the surface. In some embodiments, a surface is referred to as “high-slip” herein if it exhibits a hydrodynamic slip length b that is larger than the typical size of the ions or solvent molecules in the liquid near the surface.

The invention relates, in some embodiments, to nonlinear electro-osmotic flows in electrolytes and liquid salts, which exhibit charged interfacial double layers of width λ on the surfaces driving the flow. In some embodiments, the hydrodynamic slip length b over a surface of a device is larger than, or at least comparable to, the interfacial width λ, which in electrolytes is of order the Debye-Huckel screening length and in ionic liquids is usually at the molecular scale of the ions. A material surface whose incorporation thereof at a surface of a device, which results in such slip lengths is referred to herein, in some embodiments as a high slip polarizable surface or “HSP surface”.

In many embodiments, the HSP surface is comprised a material for which the liquid is non-wetting (exhibits a large contact angle for droplets on the surface). In some embodiments, when the devices of this invention are for use with electrolytic solutions, the HSP surface incorporated therein is solvent-phobic, or non-wetting for the solvent liquid. In some embodiments of the devices of this invention for use with water or aqueous electrolytes, the HSP surface is hydrophobic.

In some embodiments, in addition to the incorporation of a material in the device, such that high slip is promoted at a surface of the device, the device will incorporate material such that the surface is polarizable, such that non-linear (“induced-charge”) electroosmosis occurs. In some embodiments, reference to a surface being “polarizable” is if it exhibits an electrical response to an applied voltage or electric field. Examples include surfaces composed of metallic, dielectric, conducting, and semi-conducting materials, which in some embodiments may have thin, weakly polarizable, dielectric or insulating coatings. In some embodiments, a polarizable surface may comprise an electrode, whose potential is externally controlled. In other embodiments, the polarizable surface may be electrically “floating” or isolated from the external circuit driving the flow, aside from experiencing electric fields coming from the liquid. Such electrically floating, polarizable surfaces may exist on fixed structures, such as channel walls, metal patterns, or posts in a microfluidic device, or they may exist on suspended particles in the liquid, or portions thereof.

In one embodiment, this invention provides a device comprising at least one microfluidic chamber for pumping an electrolyte or ionic fluid, mixing an electrolyte or ionic fluid or a combination thereof, said chamber comprising:
a plurality of structures driving non-linear electroosmotic flow proximal to, positioned on, or comprising at least one surface of said chamber;
   wherein at least a first portion of said structures is polarizable or comprises a first material which is polarizable and at least a second portion of said structures comprises a second material, which promotes hydrodynamic slip at a region proximal to said second portion;
connectors operationally connecting said electrodes to at least one voltage source;
   whereby upon introduction of an electrolyte or ionic fluid in said device and application of said voltage, an electric field is generated in said chamber, hydrodynamic slip of a length larger than the molecular scale of the fluid is generated and non-linear electroosmotic flow is produced in said chamber.

In one embodiment, the structures are electrodes, which may comprise portions which are coated with a material, which promotes hydrodynamic slip, or in some embodiments, are placed proximally to structures comprising a material, which promotes hydrodynamic slip, for example, in a repeating sequence, such that non-linear electroosmotic flow is effected, and such flow is made more rapid as a function of the incorporation of the material promoting hydrodynamic slip.

In some embodiments, the devices incorporate a plurality of electrodes, which are arranged so as to produce:
electro-osmotic flows with at least one varied trajectory in a region of said chamber, resulting in mixing of said electrolyte fluid;
a dominant electroosmotic flow which drives said electrolyte fluid across said chamber;
or a combination thereof.

In one embodiment, the device further comprises at least one conductor element placed in an orientation that is perpendicular to the axis of said electric field, at a location within or proximal to said chamber, and in some embodiment, the conductors or portions thereof incorporate or are coated with a material, which promotes high slip at a surface proximal thereto. In one embodiment, the device further comprises:
at least two background electrodes connected to said source, providing said electric field in said chamber; and
at least one pumping element comprising two or more parallel-positioned or interdigitated electrodes positioned therebetween; wherein electrodes in said pumping element vary in height with respect to each other, said background electrodes, or a combination thereof.

In one embodiment, at least two of said plurality of electrodes or portions thereof are varied in height by at least 1%. According to this aspect and in one embodiment, the plurality of electrodes comprises at least one electrode, or a portion thereof, which is raised with respect to another electrode, or another portion of said at least one electrode, or in another embodiment, the plurality of electrodes comprises at least one electrode, or a portion thereof, which is lowered with respect to another electrode, or another portion of said at least one electrode. In another embodiment, the plurality of electrodes comprises at least one electrode or at least a to portion thereof having a height or depth, which is varied proportionally to a width of another electrode, another portion of said at least one electrode, or a combination thereof.

In one embodiment, application of said voltage is to a portion of said plurality of electrodes, as a function of time. According to this aspect and in one embodiment, the electrodes to which said voltage is applied comprise a first series and said electrodes to which said voltage is not applied comprise a second series. In another embodiment, the first series is so positioned such that an electroosmotic flow trajectory created thereby is parallel to a long axis of said device and said second series is so positioned such that an electroosmotic flow trajectory created thereby is perpendicular thereto, or vice versa. In another embodiment, the first series comprises said first plurality and said second series comprises said second plurality and the first and second series are positioned on opposing surfaces of said chamber or in another embodiment the source modulates the magnitude or frequency of the voltages applied to said series of electrodes.

In one embodiment, the voltage source is a DC voltage source and in another embodiment the voltage source is an AC or pulsed AC voltage source. In another embodiment, the voltage source is an AC or pulsed AC voltage source with a DC offset, or in another embodiment, the voltage source applies a peak to peak AC voltage of between about 0.1 and about 10 Volts. In another embodiment, the voltage applied to the electrode array varies both in time and in space as a traveling wave, moving across the electrode array in one direction. In some embodiments, the HSP surface is carbon based, which in one embodiment contains or comprises crystalline, polycrystalline or amorphous graphite or diamond. In another embodiment, the HSP surface is a carbon coating, which in one embodiment is an atomically thin graphene sheet or composite surface containing graphene platelets. In another embodiment, the HSP surface contains or comprises carbon fullerene structures such as nanotubes, nanowalls, nanohoms, nanobuds, buckyballs, or combinations thereof, which in one embodiment is adhered to said electrodes or conductors or portions thereof, for example, as a thin-film coating.

In another embodiment of the invention for use with water or aqueous solutions, the HSP surface contains or comprises a superhydrophobic polymer, which in another embodiment is a composite of said polymer with a metal to enhance its conductivity. In another embodiment, the metal in the metal-polymer composite is in the form of nanoparticles.

In another embodiment, the HSP surface is a hydrophobic glass surface or an ultrahydrophobic nanopin glass surface, forming a thin coating on a polarizable substrate. In another embodiment, a metal, which may be in the form of nanoparticles, is incorporated into asperities, such as nanopins or other nanostructures, on the hydrophobic glass surface.

In another embodiment, the HSP surface is composed of metal oxide materials, which may consist of to nanopins, nanoribbons, nanonails, nanobridges, and nanowalls, and hierarchical nanostructures and may also contain conducting additives.

In another embodiment a conducting catalyst or bonding layer is positioned between an HSP-surface material and electrodes or conductors or portions thereof.

In another embodiment, this invention provides an apparatus comprising a device of this invention.

In one embodiment, this invention provides a method of circulating or conducting a fluid, said method comprising the steps of:
applying a fluid comprising an electrolyte to a device of this invention;
applying voltage to polarizable structures, such as electrodes in the device; and
inducing an electric field in said chamber;
whereby electroosmotic flow is induced in the chamber. According to this aspect, and in one embodiment, the induced-charge electro-osmotic flow provides a method of circulating a fluid within the chamber and/or conducting a fluid through the chamber, which in one embodiment comprises an inlet and an outlet, and such device may function as a pump, in some embodiments.

In another embodiment, this invention provides a method of mixing a fluid, said method comprising the steps of:
applying a fluid comprising an electrolyte to a device of this invention;
applying voltage to polarizable structures, such as electrodes in the device; and
inducing an electric field in said chamber;
whereby electroosmotic flow is induced in said chamber, thereby being a method of circulating or conducting a fluid.

In one embodiment, the first plurality of electrodes, said second plurality of electrodes, or a combination thereof are arranged in at least two series, with each series varying in terms of an electroosmotic flow trajectory created by said series upon application of voltage thereto, from at least a series proximally located thereto on said at least one surface. In one embodiment, the voltage source applies voltage selectively to said series such that said voltage is not simultaneously or commensurately applied to all series of electrodes of said plurality whereby upon selective application of said voltage to said series, electro-osmotic flows with varied trajectories are generated in a region proximal to each of said series, resulting in chaotic mixing of said electrolyte fluid. In another embodiment, the at least two series are positioned such that an electroosmotic flow trajectory created by a first series is in a direction different from an electroosmotic flow trajectory created by a second series of said at least two series. In another embodiment, the first series is so positioned such that an electroosmotic flow trajectory created thereby is parallel to a long axis of said device and said to second series is so positioned such that an electroosmotic flow trajectory created thereby is perpendicular thereto, or vice versa. In another embodiment, the magnitude or frequency of the voltages applied to said series of electrodes is modulated, and in another embodiment, modulating said magnitude or frequency of voltages applied is via a smooth transition.

In another embodiment, there may be multiple chambers comprising the device, where fluid transport between two or more of the chambers is controlled by said method of induced-charge electro-osmotic flow. In another embodiment, there may be additional means of generating flow within or between the chambers, e.g. using pressure gradients or DC electro-osmotic flow, which are augmented by said method of induced-charge electro-osmotic flow to enhance pumping or mixing of said fluid.

In another embodiment, multiple fluids may be introduced into said chamber or chambers such that said method is useful for transporting and/or mixing multiple fluids, and in another embodiment, the method further comprises assay or analysis of said fluid.

In another embodiment, the analysis is a method of cellular analysis, which in one embodiment comprises the steps of:
a. introducing a buffered suspension comprising cells and a reagent for cellular analysis into said microfluidic chamber; and
b. analyzing at least one parameter affected by contact between said suspension and said reagent.

In another embodiment the reagent is an antibody, a nucleic acid, an enzyme, a substrate, a ligand, or a combination thereof, and in another embodiment, the reagent is coupled to a detectable marker, which in one embodiment is a fluorescent compound. In another embodiment, according to this aspect, the device is coupled to a fluorimeter or fluorescent microscope.

In another embodiment the method further comprises the step of introducing a cellular lysis agent in said port. In one embodiment, the specifically interacts or detects an intracellular compound.

In another embodiment, the assay or analysis of fluid is a method of analyte detection or assay. According to this aspect and in one embodiment, the method further comprises the steps of:
a. introducing an analyte to said device;
b. introducing a reagent to said device; and
c. detecting, analyzing, or a combination thereof, of said analyte.

In one embodiment, mixing reconstitutes a compound in the device, upon application of said fluid, and in another embodiment, the compound is solubilized slowly in fluids.

In one embodiment, mixing results in high-throughput, multi-step product formation. In one embodiment, the method further comprises the steps of:
a. introducing a precursor to the device;
b. introducing a reagent, catalyst, reactant, cofactor, or combination thereof to said device;
c. providing conditions whereby said precursor is converted to a product; and
d. optionally, collecting said product from said device.

In one embodiment the method further comprises the steps of carrying out iterative introductions of said reagent, catalyst, reactant, cofactor, or combination thereof in (b), to said device.

In another embodiment, the fluid pumping and/or mixing results in drug processing and delivery. According to this aspect and in one embodiment, the method further comprises the steps of:
i. introducing a drug and a liquid comprising a buffer, a catalyst, or combination thereof to the device;
ii. providing conditions whereby said drug is processed or otherwise prepared for delivery to a subject; and
iii. collecting said drug, delivering said drug to a subject, or a combination thereof.

In one embodiment, this invention provides a composite particle, wherein a portion of said particle is comprised of a polarizable material, further comprising or coated with a second material, which when said composite particle is suspended in a fluid and subjected to nonlinear electrophoresis, said particle exhibits a hydrodynamic slip of a length larger than the molecular scale of said fluid.

In another embodiment this invention provides a composite particle, which in one embodiment is a microparticle or in another embodiment, a nanoparticle, wherein said particle or a portion thereof is comprised of or is coated with a material exposing an HSP surface.

In one embodiment, a conducting bonding layer is positioned between said HSP-surface material and the core of the microparticle or portions thereof. In another embodiment, the microparticle further comprises a targeting moiety, a detectable marker or a combination thereof.

According to this aspect and in one embodiment, the composite particle comprises a metal. In another embodiment, the particle comprises an HSP coating around a metallic core, or in another embodiment, only a portion of said particle comprises an HSP coating.

According to this aspect and in one embodiment, the composite particle comprises a polymeric material, whose surface or a portion thereof has an HSP coating.

In one embodiment, the particle is spherical or cylindrical.

In one embodiment, the HSP-surface material is carbon-based, which in one embodiment is crystalline or amorphous graphite, in another embodiment is a carbon coating on a polymeric material, or in another embodiment is a fullerene phase of carbon. In different embodiments, said fullerene phase may contain to carbon nanotubes, nanobuds, nanohoms, buckballs or flat graphene sheets. In one embodiment, the carbon-based material is adhered to said microparticle, and in another embodiment, the microparticle (or nanoparticle) is partly or fully comprised of this material.

In another embodiment, this invention provides a method of high-speed induced-charge electrophoresis, the method comprising the steps of:
applying a fluid comprising the composite microparticle of this invention to an electrophoretic device; and
applying voltage to said device;
whereby said particles are conveyed through said fluid in response to application of said voltage.

In one embodiment, the typical electric fields in the device are in the range 1-1000 V/cm and apply voltages across the microparticle in the range 1 mM-10 V. The use of a HSP surface will allow the use of lower voltages to achieve similar induced-charge electrophoretic motion compared to particles with low-slip polarizable surfaces, in some cases by a factor in the range 1-100. In one embodiment, the particle further comprises a targeting moiety, a detectable marker or a combination thereof. In one embodiment, the fluid comprises a biological sample. In another embodiment, the method further comprises assay or analysis of said fluid or separation of components of said sample. In another embodiment, the analysis is a method of DNA analysis, a method of DNA separation, or a combination thereof.

In another embodiment, the method comprises the steps of:
a. probing a DNA sample with said particle conjugated to an oligonucleotide of interest; and
b. subjecting said DNA sample to electrophoresis, either in free solution or in a gel.
   The composite motion of the DNA attached to microparticles or nanoparticles with HSP coatings will be sensitive to the size and structure of the DNA molecules.

In some embodiments, the particle is conjugated to an antibody, a nucleic acid, an enzyme, a substrate, a ligand, or a combination thereof.

In one embodiment, this invention provides a method of circulating or conducting a fluid, said method comprising the steps of:
applying a highly concentrated electrolyte liquid, with a bulk salt concentration above 10 mM, to a microfluidic device which is capable of driving induced-charge electro-osmotic flow;
applying voltage to electrodes in said device; and
inducing an electric field in said device;
whereby electroosmotic flow is induced in said device, thereby being a method of circulating or conducting a fluid.

In some embodiments, the highly concentrated electrolyte liquid is a non-aqueous salt solution, a molten salt, or a room-temperature ionic liquid.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A schematically depicts embodiments of devices of this invention. An HSP surface (1-20) is positioned on a substrate (1-10), for example, a surface of a microfluidic device, used to enhance ICEO flow in a microfluidic device. The HSP surface may be adhered to the substrate via adhesion layer, or it may be grown from a catalyst layer on the substrate (1-30).

FIG. 1B schematically depicts embodiments of HSP surfaces of the invention, for incorporation in electrodes/pumping elements as herein described. A material with an HSP surface (1-20) may be adhered to an underlying electrode (1-40) directly or via bonding/catalyst layer (1-30), or the entire electrode/pumping element may be comprised of the HSP material. These configurations may be applied to any microfluidic device, which makes use of induced-charge electro-osmotic flows. FIG. 1C schematically depicts the incorporation of a composite structure in devices of this invention, where the composite may represent the entire structure or a surface exposed layer of the structure, which participates in the non-linear electroosmotic flow. According to this embodiment, electron-conducting nano-particle additives are suspended in a matrix of a non-wetting material for the fluid applied to the device, exhibiting ICEO flow over the surface. As shown in A, the additives may be metallic nanoparticles of roughly spherical shape. As shown in B, the additives may also be rod-like metallic particles, such as carbon nanotubes or gold nanocylinders. The matrix material, in some embodiments, may be a hydrophobic polymer or ceramic, in some embodiments, where the fluid is water or an aqueous electrolyte.

FIG. 2 schematically depicts several specific embodiments of a device of this invention. In FIG. 2A-B, a fixed-potential ICEO pump is shown in side view, with a pumping element consisting of a metal pumping element placed in between two background electrodes applying an electric field over the pumping element. In one embodiment, height differences between pumping elements and background electrodes may be achieved by raising the pumping element (A) or lowering the background electrode (B). The electrode (2-20) or (more importantly) the pumping element (2-10) may be comprised of an HSP, or have an HSP adhered thereto (2-30), optionally with the aid of a bonding layer. FIGS. 2C-E depict AC electro-osmotic pumps consisting of periodic arrays of electrodes. FIG. 2C shows a standard array of flat, co-planar electrodes, where each period contains a pair of electrodes with unequal widths and unequal gaps. FIG. 2D shows an array of equal sized and equal-spaced, but non-planar, three-dimensional electrodes, each of which has a raised step on one sides, which, in one embodiment, could be fabricated by electroplating. FIG. 2E shows another non-planar design with insulating side walls on the raised steps, so that effectively each electrode is broken into two flat, electrically connected steps. The latter two embodiments in FIG. 2D-E exemplify cases of “3D ACEO” pumps, which are generally much faster and more robust than the original planar ACEO pumps, as shown in FIG. 2C. For additional fluid mixing or in some cases even faster flow, there may also be other three-dimensional structures, such as metal cylinders, protruding vertically from the electrodes in any of these designs and breaking symmetry in the depth direction (into the page of FIGS. 2C-E). In all of these embodiments, one or more of the electrodes or portions thereof may comprise HSP materials or have HSP surface coatings.

FIG. 3 schematically depicts another embodiment of a device of this invention. In this embodiment, the HSP is in the form of carbon nanotubes (CNT) (3-20), which is adhered to a substrate (3-10) via a conducting adhesion/catalyst layer (3-30). (A) A dense array of vertical CNT on a device surface. (B) Schematic depiction of the orientation of CNT (3-20) in the direction of desired ICEO flow maximizing exposure of the side walls of the CNT. (C) Schematic depiction of a less densly packed array of CNT (3-20) interspersed with a filler material (3-40). These types of HSP surfaces can be used in the pump embodiments of FIG. 2 or in other applications of induced-charge electro-osmosis.

FIG. 4 depicts an embodiment of a device of this invention, where heterogeneous HSP surfaces are fabricated with nanopatterns of different heights and/or compositions. These patterns are at a smaller scale than the scale of the electrodes or particles described above and together form a single, heterogeneous HSP surface for any of the uses outlined above. (A) An array of raised HSP or HSP-coated nanostructures in the form of islands (4-10) or grooves (4-20), which may be placed at regular or random intervals on a substrate. The HSP or HSP-coated nanostructures may be in the form of patterned regions of at least two different materials, one polarizable (where ICEO flow is primarily generated) but of low slip length, and the other less polarizable and of greater slip length. Polarizable islands (C) or stripes (D) are distributed on the surface with spacing comparable to that of the diffuse-layer thickness, in other embodiments.

FIG. 5 depicts an embodiment of composite nanoparticles of this invention. (A) Depiction of a spherical particle having an HSP coating (5-10) around a metallic core (5-20), optionally adhered via or grown from a bonding or catalyst layer (5-30). (B) Schematic depiction of a spherical Janus particle having only a portion thereof coated with the HSP material (5-10). (C) Schematic depiction of a cylindrical particle with alternating metallic layers (5-20), and HSP layers (5-10), or HSP coated layers (5-10). These layers m also be helical, breaking chiral symmetry.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention provides, in some embodiments, devices and apparatuses comprising the same, for the mixing and/or pumping of relatively small volumes of fluid. The driving principle in these devices is termed “induced-charge electro-osmosis” (ICEO), which refers to the electro-osmotic flow resulting from the action of an electric field on its own induced charge in the liquid around a polarizable surface, whose charge adjusts in response to the field. The polarizable surface may be composed of a metallic, semi-conducting, ion-conducting, or dielectric material, possibly with a non-polarizable coating, and its voltage may or may not be externally controlled, as an electrode.

Theories of electro-osmosis in microfluidic devices have postulated a plane of no hydrodynamic slip at the inner part of the diffuse layer, within a few molecules of the solid surface. Some recent theoretical models and molecular-dynamics simulations by L Joly et al [Physical Review Letters 93, 257805 (2004); Journal of Chemical Physics 125, 204716 (2006)] have predicted that the magnitude of electro-osmotic flow at a slipping surface is generally amplified by the factor (1+b/λ) where b is the hydrodynamic slip length (defined above) and λ is the thickness of the diffuse part of the double layer over which interfacial stresses lead to fluid flow. For electrolytic solutions, λ is comparable to the Debye-Huckel screening length, which in aqueous electrolytes ranges from 1 nm for a highly concentrated salt solution to 100 nm for pure water with no added salt, and is mainly determined by the balance of thermal diffusion and mean electrostatic forces on the ions. For ionic liquids and molten salts, λ is comparable to the molecular scale of the ions and is strongly influenced by steric effects and electrostatic correlations.

This invention takes advantage of the effect of hydrodynamic slip on nonlinear induced-charge electro-osmotic flow generated at polarizable surfaces, which has not been considered before. In particular, it teaches the use of high-slip polarizable (HSP) surfaces defined above and gives numerous examples. A variety of polarizable surface/fluid interfaces may exhibit high slip lengths, in some cases as large as a few microns, which in turn, in some embodiments of this invention greatly amplify induced-charge electro-osmotic flow due to hydrodynamic slip, as compared to such interfaces with lesser slip lengths, the principle of which is utilized in the design of devices of and in the methods of this invention.

Such amplification of induced-charge electro-osmotic flow by HSP surfaces, and utilization thereof in the devices of and in the methods of this invention, in some embodiments, may be enhanced by more than an order of magnitude for induced-charge electro-osmosis in concentrated aqueous solutions (where the Debye length reaches the nanometer scale). This effect may offset the experimentally observed reduction of induced-charge electro-osmotic velocities with increasing salt concentration (typically >1 mM) since the Debye length decreases, and thus the amplification factor increases, with concentration. The use of HSP surfaces thus may extend the use of such devices to a larger class of aqueous solutions, approaching physiological salt concentrations (>1M).

In dilute aqueous electrolytes (<1 mM) and in water, where induced-charge electro-osmotic flows are strongest, there can also be a substantial enhancement of the flow rate using an HSP surface. Although the amplification should be typically less than an order of magnitude compared to a non-slipping surface, the use of HSP surfaces may lead to the fastest possible ICEO flows in a given device.

In some embodiments of the invention, induced-charge electro-osmotic flow is accomplished in devices in which non-aqueous salt solutions, molten salts, and ionic liquids are utilized. In such liquids, the double-layer thickness can reach the molecular scale, which in turn can lead to markedly enhanced electro-osmotic flow, even if the surface has only a moderately large slip length, at the scale of tens of molecules. The use of such fluids or solvents to increase the flow rate represents an embodiment of this invention. Since such liquids often have viscosities much larger than water, their use of HSP surfaces in ICEO devices may lead to useful new flows, not possible by other means.

In some embodiments, linear or nonlinear electro-osmotic flows are driven in room-temperature ionic liquids, which provide advantages, inter alia, related to electrokinetic phenomena as applied to microfluidic technologies, such as microheating and droplet-based digital microfluidics.

In one embodiment, this invention provides a method of circulating or conducting a fluid, said method comprising the steps of:
applying a liquid to a microfluidic device which is capable of inducing electro-osmotic flow;
applying voltage to electrodes in said device; and
inducing an electric field in said device;
whereby nonlinear, induced-charge electroosmotic flow is generated in said device, thereby being a method of circulating or conducting a fluid.

In one embodiment, the liquid is water or an aqueous electrolyte. In a preferred embodiment, the bulk salt concentration is below 10 mM, which in many cases enables the fastest ICEO flow. In another embodiment, the electrolyte has a greater salt concentration, up to the solubility limit, in which ICEO flows are enables by the HSP surface, which would otherwise not occur with non-slipping surfaces. In this embodiment, the liquid may be a biological fluid or saline buffer solution.

In some embodiments, the liquid is a liquid salt, such as the room-temperature ionic liquids which have been used in pressure-driven microfluidic devices by A J de Mello et al [Lab on a Chip 4, 417-419 (2004)] for temperature control or by W H Wang et al [Langmuir, online preprint 10.1021/1a701170s (2007)] for creating droplets of aqueous solutions in ionic liquids. In some embodiments, the liquid will comprise hydrophobic liquid salts such as those described in U.S. Pat. No. 6,365,301. In other embodiments, the liquid will be an emulsion of water, aqueous electrolytes, or biological fluids with a liquid salt.

It is to be understood that the devices and/or methods of this invention make use of/are applicable to any means of driving fluid flows in microfluidic devices. For example, the invention can be applied to electrode surfaces/pumping elements for AC electro-osmotic (ACEO) microfluidic devices, polarizable surfaces for (free or fixed-potential) ICEO devices, and gate-electrode surfaces for flow-FETs.

In one embodiment, this invention makes use of AC electro-osmotic devices, which pump and/or mix a fluid, by ICEO flow driven by AC or traveling-wave voltages applied at microelectrodes, which may involve three-dimensional structures, and incorporate an HSP surface. In another embodiment, the invention makes use of traveling-wave electro-osmotic devices (TWEO), which pump fluids by applying traveling waves of voltage along arrays of microelectrodes, which incorporate HSP surfaces.

In some embodiments, devices of this invention incorporate and methods of this invention make use of devices comprising an HSP layer or material, and such devices may comprise an ACEO device, comprising a micropump, such as that described by Ramos et al. [Journal of Colloid and Interface Science 217, 420-422 (1999)] or Brown et al. [Physical Review E 63, 016305 (2001)] or US Patent Application Publication No. 20050040035, or World International Property Organization PCT International Patent Application PCT/GB03/00082 filed July 2004, fully incorporated by reference herein. According to this aspect and in some embodiments, the ACEO micropump comprises the HSP layer or material. In some embodiments, devices of this invention incorporate and methods of this invention make use of devices comprising an HSP layer or material, and such devices may comprise an TWEO device, comprising a micropump, such as that described by Cahill et al. [Physical Review E 70, 036305] and Ramos et al. [Journal of Applied Physics 97, 084906 (2005)], fully incorporated by reference herein. According to this aspect and in some embodiments, the TWEO micropump comprises the HSP surface.

In some embodiments, the device in which an HSP layer or material is incorporated is a general ICEO device or fixed-potential ICEO device comprising pumps and mixers, such as those described by Bazant & Squires, [Physical Review Letters 92, 066101 (2004); Journal of Fluid Mechanics 509, 217-252 (2004)], or United States Patent Application Publication No. 20030164296, filed Dec. 16, 2002, fully incorporated by reference herein. According to this aspect and in some embodiments, the pumps and/or mixers comprise the HSP layer or material.

In some embodiments, the device in which an HSP layer or material is incorporated is an ICEO device comprising mixers, such as those described Levitan et al., in U.S. patent application Ser. No. 11/252,871, filed on Oct. 19, 2005 or nonlinear AC Flow-FET devices such as those described in Schasfoort et al. [Science 286, 942 (1999)], fully incorporated by reference herein. According to this aspect and in some embodiments, the microfluidic mixers comprise the HSP layer or material.

In some embodiments, the device in which an HSP layer or material is incorporated is an ACEO device comprising electrodes acting as particle traps, such as those described by Green et al. [Journal of Applied Physics D 33, 632-641 (2000)], Wong et al. [IEEE/AMSE Transactions on Mechatronics 9, 366-376 (2004)] and Wu [IEEE Transactions on Nanotechnology 5, 84-88 (2006)], fully incorporated by reference herein. According to this aspect and in some embodiments, the microfluidic mixers comprise the HSP layer or material.

In some embodiments, devices utilizing electroosmotic flow for their operation comprising 3D ACEO micropumps or, in some embodiments, ICEO columnar posts, may comprise carbon electrodes, deposited on, for example, a patterned substrate, e.g. made of etched glass or polymer, fabricated for example by known methods such as those described in Levitan et al., in U.S. patent application Ser. No. 11/252,871.

It will be understood that the preparation of such devices are straightforward and may be accomplished as described in the references cited herein, or via any means known to those skilled in the art. Incorporation of a HSP material in the devices may be readily accomplished by methods known in the art, and methods described herein. Many specific examples are described and cited below.

Any embodiment of a microfluidic device incorporating an HSP can be used for fluid pumping, sample mixing, and/or trapping suspended particles, as will be appreciated by one skilled in the art.

In some embodiments, the basic element of devices of this invention/basic principle of operation of the methods of this invention is to utilize surfaces comprising an HSP material to participate in driving ICEO flow.

In one embodiment, this invention provides a device comprising at least one microfluidic chamber for pumping an electrolyte fluid, mixing an electrolyte fluid or a combination thereof, said chamber comprising:
a first plurality of electrodes proximal to, positioned on, or comprising at least one surface of said chamber,
   wherein said electrodes or portions thereof are comprised of or coated with a material, which is polarizable, and promotes hydrodynamic slip at a region proximal to the material;
connectors operationally connecting said electrodes to at least one voltage source;
   whereby upon introduction of an electrolyte fluid in said device and application of said voltage, an electric field is generated in said chamber and electroosmotic flow is induced in said chamber. In some embodiments to the chamber comprises a plurality of electrodes in which at least a portion of the total number of electrodes comprise an HSP surface as described herein. In some embodiment, the chamber comprises a plurality of electrodes in which in some electrodes, at least a portion of each of the selected electrodes comprises an HSP surface as described herein. In some embodiments,

Example 1 provides a number of embodiments of devices which may incorporate electrodes/pumping elements comprising or coated with a high slip polarizable material.

In one embodiment, the plurality of electrodes are arranged so as to produce:
electro-osmotic flows with at least one varied trajectory in a region of said chamber, resulting in mixing of said electrolyte fluid;
a dominant electroosmotic flow which drives said electrolyte fluid across said chamber;
or a combination thereof.

In one embodiment, the device further comprises at least one conductor element placed in an orientation that is perpendicular to the axis of said electric field, at a location within or proximal to said chamber.

In one embodiment, the device further comprises:
at least two background electrodes connected to said source, providing said electric field in said chamber; and
at least one pumping element comprising two or more parallel-positioned or interdigitated electrodes positioned therebetween; wherein electrodes in said pumping element vary in height with respect to each other, said background electrodes, or a combination thereof.

In one embodiment, at least two of said plurality of electrodes or portions thereof are varied in height by at least 1%. According to this aspect and in one embodiment, the plurality of electrodes comprises at least one electrode, or a portion thereof, which is raised with respect to another electrode, or another portion of said at least one electrode, or in another embodiment, the plurality of electrodes comprises at least one electrode, or a portion thereof, which is lowered with respect to another electrode, or another portion of said at least one electrode. In another embodiment, the plurality of electrodes comprises at least one electrode or at least a portion thereof having a height or depth, which is varied proportionally to a width of another electrode, another portion of said at least one electrode, or a combination thereof.

In one embodiment, application of said voltage is to a portion of said plurality of electrodes, as a function of time. According to this aspect and in one embodiment, the electrodes to which said voltage is applied comprise a first series and said electrodes to which said voltage is not applied comprise a second series. In another embodiment, the first series is so positioned such that an electroosmotic flow trajectory created thereby is parallel to a long axis of said device and said second series is so positioned such that an electroosmotic flow trajectory created thereby is perpendicular thereto, or vice versa. In another embodiment, the first series comprises said first plurality and said second series comprises said second plurality and the first and second series are positioned on opposing surfaces of said chamber or in another embodiment the source modulates the magnitude or frequency of the voltages applied to said series of electrodes.

In one embodiment, the voltage source is a DC voltage source, and in another embodiment the voltage source is an AC or pulsed AC voltage source. In another embodiment, the voltage source is an AC or pulsed AC voltage source with a DC offset, or in another embodiment, the voltage source applies a peak to peak AC voltage of between about 0.1 and about 10 Volts.

In one embodiment, the microfluidic device comprises placement of the elements on a substrate, or in another embodiment, the microfluidic chamber is contiguous with the substrate.

In one embodiment, the term “a” refers to at least one, which in some embodiments, is one, or in some embodiments two or more, or in some embodiments, pairs of, or in some embodiments, a series of, or in some embodiments, any multiplicity as desired and applicable for the indicated application.

In one embodiment, the substrate and/or other components of the device can be made from a wide variety of materials including, but not limited to, silicon, silicon dioxide, silicon nitride, glass and fused silica, gallium arsenide, indium phosphide, III-V materials, PDMS, silicone rubber, aluminum, ceramics, polyimide, quartz, plastics, resins and polymers including polymethylmethacrylate (PMMA), acrylics, polyethylene, polyethylene terepthalate, polycarbonate, polystyrene and other styrene copolymers, polypropylene, polytetrafluoroethylene, superalloys, zircaloy, steel, gold, silver, copper, tungsten, molybdeumn, tantalum, KOVAR, KEVLAR, KAPTON, MYLAR, teflon, brass, sapphire, other plastics, or other flexible plastics (polyimide), ceramics, etc., or a combination thereof.

In some embodiments, the devices will comprise at least one bubble trap or at least one gas permeable membrane proximal to a microfluidic channel, which in turn may facilitate filling of such channel with a fluid as described herein.

The substrate may be ground or processed flat. High quality glasses such as high melting borosilicate or fused silicas may be used, in some embodiments, for their UV transmission properties when any of the sample manipulation and/or detection steps require light based technologies. In addition, as outlined herein, portions of the internal and/or external surfaces of the device may be coated with a variety of coatings as needed, to facilitate the manipulation or detection technique performed, to enhance flow, to promote mixing, or combinations thereof.

In one embodiment, the substrate comprises a metal-bilayer. In some embodiments, such substrates comprise adhesive or bonding layers such as titanium or chrome or other appropriate metal, which is patterned or placed between the electrode surface and another component of the device substrate, for example, between a distal gold electrode and an underlying glass or plastic substrate.

In one embodiment, the metal-bilayer is such that a metal is attached directly to an electrode, which comprises, or is attached to another component of the substrate.

In another embodiment, the substrate comprises an adhesive layer between, for example underlying glass or plastic substrate and an electrode such as a polymer, a monolayer, a multilayer, a metal or a metal oxide, comprising iron, molybdenum, copper, vanadium, tin, tungsten, gold, aluminum, tantalum, niobium, titanium, zirconium, nickel, cobalt, silver, chromium or any combination thereof. In another embodiment the substrate comprises electrodes of zinc, gold, copper, magnesium, silver, aluminum, iron, carbon or metal alloys such as zinc, copper, aluminum, magnesium, which may serve as anodes, and alloys of silver, copper, gold as cathodes.

In another embodiment, the substrate comprises electrode couples including, but not limited to, zinc-copper, magnesium-copper, zinc-silver, zinc-gold, magnesium-gold, aluminum-gold, magnesium-silver, magnesium-gold, aluminum-copper, aluminum-silver, copper-silver, iron-copper, iron-silver, iron-conductive carbon, zinc-conductive carbon, copper-conductive carbon, magnesium-conductive carbon, and aluminum-conductive carbon.

In some embodiments, the substrate may be further coated with a dielectric and/or a self-assembled monolayer (SAM), to provide specific functionality to the surface of the device to which the material is applied.

In one embodiment, the term “chambers” “channels” and/or “microchannels” are interchangeable, and refer to a cavity of any size or geometry, which accommodates at least the indicated components and is suitable for the indicated task and/or application.

In some embodiments such channels comprise the same materials as the substrate, or in another embodiment, are comprised of a suitable material which prevents adhesion to the channels, or in another embodiment, are comprised of a material which promotes adhesion of certain material to the channels, or combinations thereof. In some embodiments, such materials may be deposited according to a desired pattern to facilitate a particular application.

In another embodiment, the substrate and/or microchannels of the devices of this invention comprise a material which is functionalized to minimize, reduce or prevent adherence of materials introduced into the device. For example, in one embodiment, the functionalization comprises coating with extracellular matrix protein's, amino acids, PEG, or PEG functionalized SAM's or is slightly charged to prevent adhesion of cells or cellular material to the surface. In another embodiment, functionalization comprises treatment of a surface to minimize, reduce or prevent background fluorescence. Such functionalization may comprise, for example, inclusion of anti-quenching materials, as are known in the art. In another embodiment, the functionalization may comprise treatment with specific materials to alter flow properties of the material through the device. In another embodiment, such functionalization may be in discrete regions, randomly, or may entirely functionalize an exposed surface of a device of this invention.

In one embodiment, the invention provides for a microchip comprising the devices of this invention. In one embodiment, the microchip may be made of a wide variety of materials and can be configured in a large number of ways, as described and exemplified herein, in some embodiments and other embodiments will be apparent to one of skill in the art.

The composition of the substrate will depend on a variety of factors, including the techniques used to create the device, the use of the device, the composition of the sample, the molecules to be assayed, the type of analysis conducted following assay, the size of internal structures, the placement of electronic components, etc. In some embodiments, the devices of the invention will be sterilizable as well, in some embodiments, this is not required. In some embodiments, the devices are disposable or, in another embodiment, re-usable.

Microfluidic chips used in the methods and devices of this invention may be fabricated using a variety of techniques, including, but not limited to, hot embossing, such as described in H. Becker, et al., Sensors and Materials, 11, 297, (1999), hereby incorporated by reference, molding of elastomers, such as described in D. C. Duffy, et. al., Anal. Chem., 70, 4974, (1998), hereby incorporated by reference, injection molding, LIGA, soft lithography, silicon fabrication and related thin film processing techniques, as known in the art, photolithography and reactive ion etching techniques, as exemplified herein. In one embodiment, glass etching and diffusion bonding of fused silica substrates may be used to prepare microfluidic chips.

In one embodiment, microfabrication technology, or microtechnology or MEMS, applies the tools and processes of semiconductor fabrication to the formation of, for example, physical structures. Microfabrication technology allows one, in one embodiment, to precisely design features (e.g., reservoirs, wells, channels) with dimensions in the range of <1 μm to several centimeters on chips made, in other embodiments, of silicon, glass, or plastics. Such technology may be used to construct the microchannels of the devices of this invention, in one embodiment.

In one embodiment, fabrication of the device may be accomplished as follows: first, a glass substrate is metallized. The choice of metal can be made with respect to a variety of desired design specifications, including resistance to oxidation, compatibility with biological materials, compatibility with substrates, etc. The metallization layer may be deposited in a specific pattern (i.e. through adhesive or shadow-masked metal evaporation or sputtering), in one embodiment, or, in another embodiment, it may be etched subsequent to deposition. Metals can include, but are not limited to gold, copper, silver, platinum, rhodium, chromium, etc. In some embodiments, the substrate may be coated with an initial layer of a thin metal, which promotes adhesion of another metal to the substrate. In some embodiments, metals may also be adhered to the substrate via adhesive. In some embodiments, the substrate is ground flat to promote adhesion. In some embodiments, the substrate is roughened to promote metal adhesion.

According to this aspect of the invention, and in one embodiment, the deposited metal may either be deposited in the final topology (i.e. through a mask) or, in another embodiment, patterned post-deposition. According to the latter embodiment, a variety of methods may be used to create the final pattern, as will be understood by one skilled in the art, including inter-alia, etching and laser ablation. Mechanical forms of removal (milling, etc.) may be used, in other embodiments.

In one embodiment, gold is deposited on chromium and the gold is etched using a photoresist mask and a wet gold etchant. The chromium remains a uniform film, providing electrical connection for subsequent electrodeposition (forming the anode connection). In another embodiment, gold is deposited via electron-beam evaporation onto an adhesion layer of titanium. The gold is patterned using a wet etchant and photoresist mask. The titanium is left undisturbed for subsequent electrodeposition.

In another embodiment, the metal may be patterned prior to deposition. A shadow mask can be utilized in one embodiment. The desired shape is etched or machined through a thin metal pattern or other substrate. The etched substrate is then held parallel to the base substrate and the material is deposited via evaporation or sputtering through the mask onto the substrate. In some embodiments, this method is desirable in that it reduces the number of etch steps.

In another embodiment, the patterned surface is formed by transferring a pre-etched or stamped metal film with adhesive onto the substrate. In one embodiment, the various devices on the layer have a common electrical connection enabling subsequent electrodeposition, and are deposited strategically so that release and dicing results in proper electrical isolation.

In another embodiment, a rigid stamp is used to puncture a thin metal film on a relatively pliable elastic (plastic) substrate. The rigid stamp can have, in some embodiments sharp or blunt edges.

In some embodiments, the thickness of deposited metals is tailored to specific applications. In one embodiment, thin metal is deposited onto the surface of the wafer and patterned. According to this aspect of the invention, and in one embodiment, the patterned surface forms a common anodic connection for electroplating into a mold.

In one embodiment, molding may be used. In one embodiment, molding comprises a variety of plastics, ceramics, or other material which is dissimilar to the base substrate. In one embodiment, the molding material is removed following electroplating. In some embodiments, the molding material is sacrificial.

In another embodiment, thick (greater than a few microns) metal is deposited and subsequently etched to form raised metal features.

In other embodiments, welding, assembly via SAMs, selective oxidation of thin metals (conversion of, for instance, aluminum to aluminum oxide) comprise some of the methods used to form insulating areas and provide electrical isolation.

In other embodiments, passivation of the metal surfaces with dielectric materials may be conducted, including, but not limited to, spin-on-glass, low temperature oxide deposition, plastics, photoresists, and other sputtered, evaporated, or vapor-deposited insulators. According to this aspect, and in one embodiment, the HSP material may be thus applied to the electrodes/pumping elements of the devices of the invention.

In some embodiments, the microfluidic channels used in the devices and/or methods of this invention, which mix and/or convey fluid, may be constructed of a material which renders it transparent or semitransparent, in order to image the materials being assayed, or in another embodiment, to ascertain the progress of the assay, etc. In some embodiments, the materials further have low conductivity and high chemical resistance to buffer solutions and/or mild organics. In other embodiments, the material is of a machinable or moldable polymeric material, and may comprise insulators, ceramics, metals or insulator-coated metals. In other embodiments, the channel may be constructed from a polymer material that is resistant to alkaline aqueous solutions and mild organics. In another embodiment, the channel comprises at least one surface which is transparent or semi-transparent, such that, in one embodiment, imaging of the device is possible. In some embodiments, the device is a closed system, with access to the chambers/channels of such devices accomplished via specialized ports.

In some embodiments, the devices of this invention have at least one inlet and/or at least one outlet.

In one embodiment, the inlet, or in another embodiment, the outlet may comprise an area of the substrate in fluidic communication with one or more microfluidic channels, in one embodiment, and/or a sample reservoir, in another embodiment inlets and outlets may be fabricated in a wide variety of ways, depending upon, in one embodiment, other substrate material utilized and/or in another embodiment, the dimensions used. In one embodiment inlets and/or outlets are formed using conventional tubing, which prevents sample leakage, when fluid is applied to the device, under pressure. In one embodiment inlets and/or outlets are formed of a material which withstands application of voltage, even high voltage, to the device. In one embodiment, the inlet may further comprise a means of applying a constant or time-varying pressure, to generate pressure-driven flow in the device.

In one embodiment, HSP material is carbon based, which in one embodiment is crystalline or amorphous graphite. In another embodiment, the HSP surface is a carbon coating, which in one preferred embodiment is a graphene sheet or a composite of graphene platelets. In another embodiment, the carbon-based material is composed of fullerenes of carbon, such as nanotubes, nanowalls, nanohorns, nanobuds, nanoballoons, buckyballs, or a combination thereof, which in one embodiment is adhered to said electrodes or portions thereof and in another embodiment may be arranged in a nanoforest, nanocarpet, or nanoarray. In another embodiment, said carbon material is interspersed in a composite matrix, such as a polymer.

Many methods and apparatuses to fabricate carbon electrodes and structures or carbon coatings in desired locations and patterns are known in the art, although all were intended and have only been used for different devices and methods than the present invention. The fabrication of carbon-based materials comprising HSP structures and surfaces of the ICEO microfluidic devices of this invention may be accomplished by any means, including, for example, those described in U.S. Pat. No. 4,647,748, U.S. Pat. No. 7,071,023, U.S. Pat. No. 7,250,148, U.S. Pat. No. 7,229,747, U.S. Pat. No. 7,226,663, US Patent Application Publication Number 20070184969, US Patent Application Publication Number 20070134866, US Patent Application Publication Number 20070114120, US Patent Application Publication Number 20070092431, US Patent Application Publication Number 20070071668, US Patent Application 20070187694, US Patent Application 20070158618, or US Patent Application 20070184190; V. Derycke, et al., NanoLetters, Vol. 1, p. 453-456, 2001; Jing Kong, et al. Nature, Vol. 395, p. 878-881, 1998, Tzeng, Y. et al., Diamond and Related Materials, Volume 12, Issues 3-7, March-July 2003, Pages 774-779, or variations thereof, all of which are incorporated by reference herein in their entirety.

In another embodiment, the carbon material for the devices of the invention is formed using C-MEMS technology [Wang et al., IEEE Journal of MEMS 14 (2), 348-358 (2005)] by pyrolizing a patterned carbon-containing precursor polymer substrate. This fabrication method is known in the art and described in US Patent Application Number 20050255233, or US Patent Application Number 20060068107 or variations thereof, which are incorporated herein by reference in their entirety. In another embodiment, the carbon is in the form of carbon black, or other products of combustion reactions.

In order to increase the electrical conductivity of any of these carbon surfaces, in another embodiment of this aspect of the invention, metals, such as gold, platinum, titanium, copper, zinc, aluminum, or alloys, may also be incorporated into the substrate or in the surface layer, as part of the fabrication process. In one embodiment, the metallic additives are in the form of nanoparticles incorporated into the substrate or HSP material. In another embodiment, the metal nanoparticles are carbon-encapsulated or attached to carbon nanotubes or other fullerenes. The incorporation of metals into nanostructured carbon materials to enhance conductivity can be accomplished by many known methods, for example as described U.S. Pat. No. 7,259,188, U.S. Pat. No. 7,244,374, US Patent Application 20060233692, US Patent Application Number 20050186333, US Patent Application Number 20070218283, US Patent Application Number 20070163769, or variations thereof, which are incorporated herein by reference in their entirety.

In another embodiment a conducting catalyst layer or a conducting bonding layer is positioned between said high slip polarizable material and said electrodes, polarizable structures, or portions thereof. For example, carbon fullerene structures may be grown in a carbon-containing plasma from an iron or molybdenum catalyst layer on a heat-resistant glass or silicon substrate. Such materials and methods of their incorporation are known in the art, and are contemplated herein, for example as described in some of the references cited herein, which serve as non-limiting examples to accomplish the preparation of the devices as herein described.

In another embodiment of the invention for use with water and aqueous electrolytes, the HSP surface is composed of a hydrophobic polymer material, which in another embodiment may have its conductivity enhanced by a metallic additive. There many known methods to produce superhydrophobic or ultrahydrophobic surfaces with polymeric materials, for example, as described by Wei Chen et al [ACS Journal of Surfaces and Colloids 15, 3395-3399 (1999)], SR Coulson et al [Journal of Physical Chemistry B 104, 8836-8840 (2000)], or H Yildirim Erbil et al [Science 299, 1377-1380 (2003)], or variations thereof, which are incorporated by reference herein in their entirety. These materials may be used as thin-film coatings on metal structures of electrodes in the devices of this invention, but it is preferable to use superhydrophobic materials with high conductivity, which can be achieved by dispersing metallic particles, nanoparticles, or matrix phases in a suitable polymer-metal composite. Fabrication methods are also known for hydrophobic, conducting polymer/metal composites, for example as described in U.S. Pat. No. 7,112,369, which is incorporated herein by reference in its entirety.

In another embodiment, the HSP surface is an ultrahydrophobic surface with nanoscale roughness, which forms a thin coating on a polarizable substrate in a device of this invention. In one embodiment, said surface is a nanopin surface, with conical pin-like nanostructures, which in one embodiment is composed of a brucite-type cobalt hydroxide on a borosilicate glass. In another embodiment, a metal, which may be in the form of nanoparticles, may incorporated into the nanopin surface enhance its conductivity. There are a variety of known methods to fabricate nanostructured hydrophobic surfaces, as in E. Hosono et al. [Journal of the American Chemical Society 127, 13458-13459 (2005)] or US Patent Application 20070190299, or variations thereof, which are incorporated by reference herein in their entirety.

In another embodiment, the HSP surface is composed of metal-oxide materials, which may consist of nanopins, nanoribbons, nanonails, nanobridges, and nanowalls, and hierarchical nanostructures, for example, as described in US Patent Application 20040105810, which is incorporated herein by reference in its entirety.

In another embodiment, this invention provides an apparatus comprising a device of this invention.

In one embodiment, a “device” or “apparatus” of this invention will comprise at least the elements as described herein. In one embodiment, the devices of this invention comprise at least one channel, which may be formed as described herein, or via using other microfabrication means known in the art. In one embodiment, the device may comprise a plurality of channels. In some embodiments, the devices of this invention will comprise a plurality of channels, or microchannels. In one embodiment, the phrase “a plurality of channels” refers to more than two channels, or, in another embodiment, channels patterned according to a desired application, which in some embodiments, refers to channels varying by several orders of magnitude, whether on the scale of tens, hundreds, thousands, etc., as will be appreciated by one skilled in the art.

In one embodiment, the devices of this invention mix and optionally pump fluids using non-linear electroosmotic flow generated within the device, whereby such flow is enhanced as a function of the incorporation of an HSP surface within the device, or in another embodiment, when a concentrated electrolyte, molten salt, or ionic liquid is applied to the devices, whose flow is enhanced by the HSP surface, as herein described.

In one embodiment, the devices of this invention comprise electrodes connected to a source providing an electric field in the microchannel, wherein the device comprises two or more parallel or interdigitated electrodes, which when in the presence of electrolyte fluids in the device and application of the field produce electro-osmotic flows so that said electrolyte fluid is driven across the microfluidic channels.

In some embodiments, the term “electrode” is to understood to refer to the metal electrode per se, as well as a substrate onto which such an electrode is affixed, or which comprises the electrode, or is proximal to the electrode. The term electrode will include, in some embodiments, coating with an HSP material, or in some embodiments, complexing with an HSP material, for example, by affixing complex structures of an HSP material to a surface of the electrode. In some embodiments, the term electrode refers to a conductive material which is heterogeneous, incorporating two or more materials throughout its structure, or in some embodiments, in discrete domains within the structure, wherein one of the two or more materials will be an HSP. Any combination of such HSP incorporation is envisioned as well, representing additional embodiments of the invention.

The electrodes of the devices of this invention, in some embodiments, will have varied height, in some embodiments, or in other embodiments, will not be co-axial, with regard to Cartesian axes, in more than one dimension. It is to be understood that with reference to varied spatial apportionment of the electrodes, e.g. their height, that such reference is in terms of the vertical placement of the electrode, as well as the electrode placed on an underlying substrate. For example, this invention is to be understood to comprise a chamber comprising a pair of electrodes, wherein the electrodes have a comparable width and depth, however one electrodes height may be 10 micron with another being 40 microns, or with another also being 10 microns, however the electrode is positioned on a substrate of 30 microns in height.

It is to be understood that with reference to variance in height, such reference is to be understood to to encompass distance normal or orthogonal to the surface on which the electrodes are placed, or in other embodiments, in the direction orthogonal to the mean plane of the surface while, for example, “horizontal” may refer to a direction coplanar with the mean plane of the surface.

In some embodiments, the arrangement of the electrodes is such so as to promote pumping and/or mixing of the materials in the microchannel, as will be appreciated by one skilled in the art, and as exemplified herein.

In some embodiments, the geometries of the electrodes are varied so as to promote mixing of the fluid or suspended particles, cells, or droplets, in discrete regions of the channel, and/or conveyance of the mixed material.

In some embodiments, the device is so constructed so as to promote mixing in certain channels and conveyance to other channels, which in turn may comprise additional steps, which require mixing, as described herein.

In some embodiments, the devices of this invention facilitate deposition of fluids at a site distal to the microchannels, for further processing, or other manipulations of the conveyed material.

In some embodiments, induced-charge electroosmosis in the devices of this invention result in the creation of a dominant flow. The term “dominant flow” refers, in some embodiments, to propulsion of fluid in a desired direction (also referred to as “positive direction”), with minimal, or less propulsion of fluid in an undesired direction (also referred to as “negative direction”). In some embodiments, dominant flow is faster than flow in the undesired direction, and such differences in flow rate, may, in some embodiments, be a reflection of orientation of the electrodes/pumping elements, whereby electrodes/pumping elements comprising or coated with an HSP are so arranged to promote faster flow in the dominant direction, whereas other electrodes/pumping elements which do not incorporate an HSP are oriented such that flow driven from these electrodes/pumping elements is in the negative direction.

In other embodiments, a three-dimensional geometry of polarizable structures and/or electrodes leads to situations where a larger fraction of the surfaces driving induced-charge electro-osmotic flow all promote flow in the same dominant positive direction, including surfaces which might locally be pumping in the negative direction. For example, as described below, some embodiments of the invention involves the use of HSP surfaces on electrode arrays in three-dimensional AC electro-osmotic pumps (3D ACEO) of U.S. patent application Ser. No. 11/700,949, Bazant and Ben [Lab on a Chip 6, 1455-1461 (2006)], Urbanski et al [Applied Physics Letters 89, 143508 (2006)], Urbanski et al [Journal of Colloid and Interface Science 309, 332-341 (2007)] or Burch and Bazant [arXiv:0709.1304v1]. In these embodiments, the majority of surfaces of the electrodes produce local ICEO flows which contribute to a dominant flow over the electrode array in the positive direction, even those surfaces with local electro-osmotic flow in the negative direction, so accordingly in some embodiments of these devices all exposed electrode surfaces are composed of HSP to material.

In some embodiments, electrodes in devices of this invention are likewise proportioned in terms of width, likewise proportioned in terms of their depth, however the height of each electrode, or in some embodiments, the height of portions of each electrode, or in some embodiments, the height of pairs of electrodes, or in some embodiments, the height of portions of electrode pairs are varied. In some embodiments, such height alterations may comprise raised or stepped electrode structures, or lowers or recessed electrode structures in a device to provide vertical differences in the electrode structure.

In some embodiments, the terms “height alterations” or “height variance” or other grammatical forms thereof, refer to differences in height, which exceed by at least 1.5%, or in some embodiments, 3%, or in some embodiments, 5%, or in some embodiments, 7.5%, or in some embodiments, 10%, or more the referenced electrode. For example, a planar electrode pair in an array may vary in height by up to 0.25%, as a result, for example, of different deposition of material forming the electrodes on a surface of a channel in the device. In the devices of this invention, in contrast, height variances between at least two electrodes, or electrode pairs, or series in a given device, will be more pronounced, and not a reflection of undesired variance due to material deposition.

In some embodiments, the term “dominant flow” refers to electroosmotic flows, or flows as a result of application of an electric field in a chamber of the devices of this invention. It is to be understood that a dominant flow may be instituted that is less in magnitude, or varied in direction, for example, than other flows in the device, such as other background flows, pressure-driven flows, or linear electro-osmotic flows for applying materials to the device, etc.

In some embodiments, the devices of this invention may cause flows for mixing or controlling flow rate (faster/slower/stopping/starting . . . ) in a channel which also has a stronger more “dominant” background flow (e.g. pressure-driven from elsewhere), where the device's dominant effect is still smaller than the background flow, yet is nonetheless greater in magnitude than similar electroosmotic flows would be with the use of planar electrodes. “Dominant” in reference to flows caused by the devices/apparatuses/methods of this invention may be understood, in some embodiments, to specifically exclude background flow, or non-electroosmotic flow.

This invention, in some embodiments, provides for fast chaotic mixing. In some embodiments, such fast chaotic mixing is accomplished via creating opposing flows as a function of their orientation within a device. In some embodiments, such orientation may make use of electrodes/pumping units/conductors, which are coated, or uncoated, or placement of coated versus uncoated to maximize flow speed in a particular series versus another of the electrodes/pumping units/conductors, which in turn contributes to chaotic mixing. In some embodiments, such fast chaotic mixing may be achieved via the temporal modulation of electro-osmotic flows in the device, such that chaotic mixing of the fluid is accomplished. In some embodiments, such modulation may result in creating multiple dominant flows, sequentially, as a function of engagement of a particular series of electrodes.

In other embodiments, a background flow (driven by pressure, linear or nonlinear electrokinetics, capillarity, mechanical motion, or other forcing) transports the fluid in one dominant direction over ICEO devices comprising electrodes/pumping units/conductors which drive secondary ICEO flows which are modulated in space, but not necessarily in time. In such embodiments, the distance downstream in the background flow acts like “time”, and again chaotic mixing can be achieved.

To illustrate temporal modulation of ICEO flows for mixing, in some embodiments, two or more series of electrokinetic pumps operating in different directions are turned on and off either at specific intervals, or in some embodiments, at set patterns, or in some embodiments, randomly to mix. The term “series” in some embodiment, refers to positioning and modulation of at least one or a group of electrodes as described herein, such that electroosmotic flows arising upon their engagement act on overlapping volumes of fluid in different directions, or in some embodiments, at a comparable or similar flow rate. In some embodiments, pumps in a series as described herein may encompass pumps located proximally along a Cartesian axis, wherein the electrodes/pumps have at least one surface of such structure abutting a common substrate. In some embodiments, pumps in a series as described herein may encompass pumps located proximally along a Cartesian axis, wherein the electrodes/pumps do not share a common substrate. In some embodiments, a series of pumps may be alternating with another series of pumps, such that for example a first series of pumps results in horizontal fluid flows, whereas the second series results in vertical fluid flows, and such series may alternate, such that overall flow may follow a patter, for example, and in one embodiment, wherein flow is horizontal, then vertical, then horizontal and vertical again. In some embodiments, the series of pumps may have more than two dominant flow directions, such as north, east, south, west, which alternate in time in their dominance of the flow in the mixer. In some embodiments, pumps in a series will comprise electrodes/pumps, which comprise an HSP, or in some embodiments, some electrodes/pumps in a series comprise the HSP and some do not.

It will be appreciated by the skilled artisan that it may be desirable to have smooth transition between engagement of the respective series of electrodes. Such transition can be effected by any number of means, for example via ensuring that the modulating waveform (which provides a sinusoidal envelope for the magnitude of the AC voltage at the operating frequency) is phase shifted by 90 degrees (¼ period) between one pump and the other, so that one is effectively on while the other is off, with the ability to control, in some embodiments, that switching is a smooth transition from one pump to the other, and not sudden.

In some embodiments, the characteristic time scale for switching is comparable to the time for flow to circulate at least halfway around the vortex generated by the pump in the cavity. According to this aspect, and in one embodiment, the switching leads to stretching and folding in the two different pumping directions, to which produces chaotic streamlines and very rapid mixing in the same way as the rolling of dough in a bakery.

In some embodiments, electrodes within a series may vary in terms of their height, width, shape, etc. In some embodiments, a series as described herein may be defined by the physical placement of the electrodes within the series, or in another embodiment, by the overall flow of fluid once the electrodes which comprise the series are engaged.

In some embodiments, the devices of this invention include an alternating current electrical controller e.g., which is capable of generating a sine or square wave field, or other oscillating field, which allows for modulation of engagement of a particular series of electrodes, as described herein.

In some embodiments, the devices of this invention include a voltage controller that is capable of applying selectable voltage levels, simultaneously or sequentially, e.g., to a series of electrodes. Such a voltage controller is optionally implemented using multiple voltage dividers and multiple relays to obtain the selectable voltage levels. In some embodiments, multiple independent voltage sources are used. In some embodiments, the voltage controller is as described in U.S. Pat. No. 5,800,690. In some embodiments, modulating voltages affects a desired fluid flow characteristic, e.g., continuous or discontinuous (e.g., a regularly pulsed field causing the sample to oscillate direction of travel), and/or direction of such flow, thereby contributing to chaotic mixing as described herein.

In another embodiment, the electrodes are arranged in a gradient pattern in the microfluidic devices of this invention.

The term “gradient”, in some embodiments, refers to an arrangement which has gradual or gradated differences, for example in electrode height, from one terminus of such arrangement to another, or in some embodiments, gradual or gradated differences, for example in electrode width, gradual or gradated differences, for example in electrode depth, gradual or gradated differences, for example in electrode shape, gradual or gradated differences, for example in electrode circumference, gradual or gradated differences, for example in the angle at which each electrode is deposited in an array in a device of the invention, or gradual or gradated differences, in any combination thereof, or any desired parameter of the same. In some embodiments, the term gradual or gradated differences refers to differences, which are based on a pattern, in ascending or descending value, which may be consecutive or non-consecutive.

In some embodiments, the term “gradient” refers to any of parameter with regard to electrode geometry, which may vary by any defined/desired period, for example incrementally, or as a multiple or exponential scale, in one or more directions. For example, the layout (gaps, widths, heights, etc.) of each pair of electrodes in an interdigitated array could be resealed to get larger (or smaller) with distance along the array in the direction of pumping so that the local pumping flow is slower (or faster).

In some embodiment, a series is defined by specific intervals in such a gradient arrangement. In to some embodiments, each graduated change defines a series. In some embodiments, changes in flow, as a function of placement within a gradient defines a series.

In some embodiment, the gradient may be a function of the gaps between electrodes, spacing of electrodes, height of electrodes or portions thereof, shapes of electrodes or portions thereof, or a combination thereof.

In some embodiments, a pair may define a series, or in some embodiments a series is defined by any desired number of electrodes.

In some embodiments, arrangement of electrodes which vary in at least 2 or 3 dimensions, in a series may be such that when a field is applied, one of the electrodes in the pair promotes fluid conductance in a particular direction, and another series promotes fluid conductance in another direction. In some embodiments, such electrodes may be constructed in particular geometries, as described herein, and as will be appreciated by one skilled in the art, such that fluid conductance in the desired direction, versus the alternate direction is optimized.

In some embodiments, a series of electrodes/pumping units are so positioned as described herein, which promote chaotic mixing, and such series are positioned proximal to another series or pair of series, which in turn, via the methods of modulation as herein described, promotes fluid flow in a dominant direction, such that mixing of the fluid is localized to the electrodes involved in chaotic mixing, and once mixing is sufficient, the fluid is then conveyed in a dominant direction by the latter electrode series. Various permutations of such arrangements to promote mixing and/or conveyance are readily apparent to one skilled in the art.

In some embodiments, the electrodes may be arranged in a series, with varying at least 2 of the 3 dimensions of at least one electrode in a given series. Such series may be odd- or even-in number. In some embodiments, the electrodes in a given series may vary in any way as described herein in terms of electrode geometry, patterning in the device, or a combination thereof, and the devices of this invention may comprise multiple series, which in turn may add to the complexity of the arrays of electrodes and capabilities of the devices of this invention.

In another embodiment, the gaps are between about 1 micron and about 50 microns, and in another embodiment, the electrode widths are between about 0.1 microns and aboout 50 microns.

In some embodiments, the term “dominant flow” refers to propulsion of fluid in alternating directions, which may be modulated, for example via varying the frequency or strength of the field applied, and/or varying or modulating the electrode heights, or portions thereof, resulting in a net conveyance of fluid in a desired direction at a specific time or condition. In some embodiments, the term “dominant flow” refers, to greater propulsion of fluid in a positive rather than negative direction. In some embodiments, the term “greater propulsion” refers to a net propulsion of 51%, or in another embodiment, 55%, or in another embodiment, 60%, or in another embodiment, 65%, or in another embodiment, 70%, or in another embodiment, 72%, or in another embodiment, 75%, or in another embodiment, 80%, or in another embodiment, 83%, or in another embodiment, 85%, or in another embodiment, 87%, or in another embodiment, 90%, or in another embodiment, 95% of the fluid being conveyed in a device of the invention, in a desired or positive direction. In some embodiments, the term “greater propulsion” reflects propulsion of the amount of fluid conveyed in a desired direction as a function of time, with propulsion being greater in a desired direction, predictably, in comparison to a similarly constructed device comprising electrodes of comparable, as opposed to varied height.

In some embodiments, the term “dominant flow” reflects propulsion of fluid conveyed in a desired direction, wherein such fluid is well mixed during, or prior to conveyance in a net desired direction.

The devices of this invention enable conveyance of a fluid, which is an electrolyte fluid. In one embodiment, the term “electrolyte fluid” refers to a solution, or in another embodiment, a suspension, or, in another embodiment, any liquid which will be conveyed upon the operation of a device of this invention. In one embodiment, such a fluid may comprise a liquid comprising salts or ionic species. In one embodiment, the ionic species may be present, at any concentration, which facilitates conduction through the devices of this invention. In one embodiment, the liquid is water, or in another embodiment, distilled deionized water, which has an ionic concentration ranging from about lOnM to about 0.1M. In one embodiment, a salt solution, ranging in concentration from about lOnM to about 0.1M is used.

In one embodiment, the devices of this invention comprise a series of electrodes, wherein each series comprises electrodes, which are not flat. In some embodiments, the electrodes are so constructed so as to comprise sections having at least two different vertical positions. In some embodiments, the transition between sections of different vertical heights is smooth, or in other embodiments, step-wise. In some embodiments, the different vertical positions of the sections differ with respect to other sections in the same electrode, and in some embodiments, with other electrodes of which the series is comprised.

In some embodiments, the devices of this invention comprise electrodes, which are interlaced electrodes, which can be varied to adjust the mixing capability of the device and optionally the frequency response and/or rate of fluid conductance.

In some embodiments, the elements of the device are so arranged so as to promote passage of mixed fluid over a sensor on, for example, a wall of the microchannel.

The design of electrodes which comprise sections which vary in terms of their vertical position may be readily accomplished by known means in the art. For example, the devices may be fabricated as described herein, with successive electroplatings in order to alter the height, shape, etc. of the electrode. In some embodiments, such manufacture results in the production of electrodes with smooth transitions between the to different vertical positions, and in other embodiments, with step-wise transitions, which vary in terms of the degree of drop between the different vertical positions. Positioning of these electrodes within the device, will, in some embodiments, be a reflection of a desired flow rate through the devices of this invention. In some embodiments, construction of the devices with such pumping elements facilitates greater flow rate, as a function of a “conveyor-belt” phenomenon, as described and exemplified herein.

Some embodiments of arrays or electrode series as herein described, and polarity of the respective electrodes may be varied as a function of their placement in the device, as will be appreciated by one skilled in the art. In some embodiments, the electrodes are arranged with a variety of geometries, such as a square, hexagon, interlocking or inter-digitating designs, etc., as will be appreciated by one skilled in the art. Such orientation may be particularly useful in promoting mixing of the fluids used in the devices and methods of this invention. In some embodiments, such positioning will also reflect the positioning of electrodes/pumping elements/conductors comprising an HSP, to maximize conveyance and/or mixing of fluid in the device. In some embodiments, the positioning of electrodes/pumping elements/conductors comprising an HSP (+HSP), is relative to positioning of electrodes/pumping elements/conductors not comprising an HSP (−HSP), such that orientation of +HSP is oriented in a particular direction relative to −HSP, or in some embodiments in a particular pattern, or in another embodiment, with a particular spacing along a particular axis, etc.

In one embodiment, the term “mixing” as used herein refers to circulation of materials to promote their distribution in a volume of space, for example, a mixture of 2 species, in a device of this invention, refers, in one embodiment, to a random distribution of the 2 species within a given volume of space of the device, e.g., in a microchannel of the devices of this invention. In one embodiment, the term “circulation” and “mixing” are interchangeable. In one embodiment, mixing refers to a change in a particular distribution which is not accompanied by agitation of the sample, in one embodiment, or in another embodiment, minimal agitation and/or formation of “bubbles” in the liquid medium in which the species are conveyed.

While the electrode and field polarities as “+” and “−” signs throughout, all fields can also be AC or DC corresponding to electrode polarities oscillating between + and −, giving rise to the same induced-charge electro-osmotic flow. Thus all of the devices of the invention can operate in AC or DC, although in screening of the electrodes will limit the duration of a DC flow, unless Faradaic reactions or other mechanisms cause the electrodes to sustain a steady current.

In some embodiments, the present invention provides for the operation of the device in AC with DC offset, as will be understood by one skilled in the art, for example, as described in U.S. Pat. No. 5,907,155. In another embodiment, asymmetric driving signals may be used.

In some embodiments, this invention takes advantage of the fact that there is a competition between regions of oppositely directed electro-osmotic slip on the surfaces of interlaced electrodes of opposite polarity, which in turn results in net pumping over the surface. According to this aspect of the invention, by to raising the surfaces pumping in the desired direction (and/or lowering those not pumping in the desired direction) one effectively “buries” the reverse convection rolls. If the height difference is comparable to the width of the buried electrodes, the reverse convection rolls turn over near the upper surface and provide an effective “conveyor belt” for the primary pumping flow over the raised electrodes, as further described and exemplified herein below.

In some embodiments, the devices of this invention comprise raised electrodes, or in other embodiments, raised portions of electrodes, whose height is about proportional to the width of the unraised, recessed or combination thereof electrode, or portion of an electrode. In some embodiments the raised electrodes and/or raised portions of electrodes, have a height less than the width of the unraised electrode, or portion thereof. In some embodiments, the term “less than” in this context is by a value of about 1%, or about 5%, or about 8%, or about 10%, or about 15%, or about 17%, or about 20%, or about 25% or about 50%, as compared to the referenced value or parameter.

In some embodiments, the term “about” as used in this invention, is to be understood to encompass a value deviating by +/−1%, or in another embodiment, by +/−2.5%, or in another embodiment, by +/−5%, or in another embodiment, by +/−7.5%, or in another embodiment, by +/−10%, or in another embodiment, by +/−15%, or in another embodiment, by +/−20%, or in another embodiment, by +/−25%, with respect to the referenced value or parameter.

This invention provides, in some embodiments, specific designs for periodic three-dimensional electrode structures, which may achieve much faster flows by up to several orders of magnitude compared to existing planar AC electro-osmotic pumps, for the same applied voltage and minimum feature size, due in part to the incorporation of an HSP material in the electrodes/pumping elements/conductors of this invention, as well as the special three-dimensional geometry. It is to be understood that the term “incorporation of an HSP material” refers to any such incorporation, including for example, surface coating, adherence of a layer of an HSP to the electrodes/pumping elements/conductors of this invention, construction of an electrodes/pumping elements/conductors of this invention from an HSP material, wherein in some embodiments, parts of such electrodes/pumping elements/conductors comprise the HSP and other regions within the same do not. In some embodiments, the term “incorporation of an HSP material” refers to adherence of any complex HSP structure to the electrodes/pumping elements/conductors, in the devices as described herein.

External circuitry can be used to control electrical connections and/or to fix the voltage/potential of any or all of the electrodes. Background electrode potential can be controlled relative to the pumping element electrodes in magnitude, frequency, and phase lag.

In some embodiments, the total charge on the electrodes can also be controlled. Charge can be controlled relative to the background electrodes in magnitude, frequency, and phase lag, as above.

In some embodiments, additional electrode geometries can include rounded portions, which can be fabricated for instance, by evaporating through a narrow slit, or by wet etching a vertical, electroplated electrode.

In some embodiments, the background electrodes can be arranged in a variety of geometries relative to the pumping electrode. The background electrodes can be parallel to one another and transverse to a background fluid flow, or in other embodiments, they can be parallel to one another and parallel to background fluid flow. In some embodiments, they can have an angle between them, resulting in some electric field gradients, which may enhance fluid mixing.

The electrical connections between electrodes and external circuitry can, in some embodiments, be as simple as planar wires connecting the center posts to the external circuits. The electrical connections can be electroplated, in some embodiments. The electrical connections can be buried beneath an insulating material, in some embodiments.

Driving and control electronics can be manufactured on-chip along with the electrodes, in some embodiments. The driving and control electronics can be a separate electronics module, in some embodiments, an external stand-alone unit or microfabricated electronics. The microfabricated electronics module, in some embodiments, can be wire-bonded to the chip containing the electrodes or can be flip-chip bonded.

Fluidic channels can be fabricated by a variety of means, including soft-lithographic molding of polymers on rigid or semi-rigid molds. Channels can also be fabricated in glass via wet etching, plasma etching or similar means. Channels can be formed in plastics via stamping, hot embossing, or other similar machining processes. The channels can then be bonded to the substrate containing the electrode structures. Alignment marks can be incorporated onto the substrate to facilitate assembly. In some instances, metal surfaces can be exposed on substrate and channels to enable metal-to-metal bonding. Glass-to-glass bonding can be done at elevated temperatures and with applied potential. Plastic-to-glass can be facilitated with cleaning of glass surfaces prior to bonding, or fabrication of the fluidic portion of the device can be accomplished by any means known in the art.

Raised supports of an insulating or semiconducting nature can be fabricated on the substrate as well, in some embodiments, on which the pumping electrodes and/or background electrode may be mounted, to provide for differences in height, for uses as described herein.

In some embodiments, this invention provides a device comprising a microfluidic loop. In some embodiments, the device will comprise ports and machinery such that fluid injected in one port can be recirculated across one or more regions of the device, for example to regions for the detection of materials, or in some embodiments, separation of material, or in some embodiments, mixing of materials, which may be effected by the micropumps of the devices of this invention, prior to ejection through another port, in some embodiments, as described and exemplified herein.

In one embodiment, the device is adapted such that analysis of a species of interest (molecules, ions, colloidal particles, cells, droplets, bubbles, etc.) may be conducted, in one embodiment, in the device, or in another embodiment, downstream of the device. In one embodiment, analysis downstream of the device refers to removal of the obtained product from the device, and placement in an appropriate setting for analysis, or in another embodiment, construction of a conduit from the device, for example, from a collection port, which relays the material to an appropriate setting for analysis. In one embodiment, such analysis may comprise signal acquisition, and in another embodiment, a data processor. In one embodiment, the signal can be a photon, electrical current/impedance measurement or change in measurements. It is to be understood that the devices of this invention may be useful in various analytical systems, including bio-analysis micro-systems, due to the simplicity, performance, robustness, and ability to be integrated to other separation and detection systems and any integration of the device into such a system is to be considered as part of this invention. In one embodiment, this invention provides an apparatus comprising a device of this invention, which in some embodiments, comprises the analytical modules as described herein.

In one embodiment, this invention provides a method of circulating or conducting a fluid, said method comprising the steps of:
applying a fluid comprising an electrolyte to the device of claim 1;
applying voltage to said electrodes; and
inducing an electric field in said chamber;
whereby electroosmotic flow is induced in said chamber, thereby being a method of circulating or conducting a fluid.

In another embodiment, this invention provides a method of mixing a fluid, said method comprising the steps of:
applying a fluid comprising an electrolyte to the device of claim 1;
applying voltage to said electrodes; and
inducing an electric field in said chamber;
whereby electroosmotic flow is induced in said chamber, thereby being a method of circulating or conducting a fluid.

In one embodiment, the first plurality of electrodes, said second plurality of electrodes, or a combination thereof are arranged in at least two series, with each series varying in terms of an electroosmotic flow trajectory created by said series upon application of voltage thereto, from at least a series proximally located thereto on said at least one surface. In one embodiment, the voltage source applies voltage selectively to to said series such that said voltage is not simultaneously or commensurately applied to all series of electrodes of said plurality whereby upon selective application of said voltage to said series, electro-osmotic flows with varied trajectories are generated in a region proximal to each of said series, resulting in chaotic mixing of said electrolyte fluid. In another embodiment, the at least two series are positioned such that an electroosmotic flow trajectory created by a first series is in a direction opposite to an electroosmotic flow trajectory created by a second series of said at least two series. . In another embodiment, the first series is so positioned such that an electroosmotic flow trajectory created thereby is parallel to a long axis of said device and said second series is so positioned such that an electroosmotic flow trajectory created thereby is perpendicular thereto, or vice versa. In another embodiment, the magnitude or frequency of the voltages applied to said series of electrodes is modulated, and in another embodiment, modulating said magnitude or frequency of voltages applied is via a smooth transition.

In another embodiment, multiple fluids may be introduced into said chamber such that said method is useful for mixing multiple fluids, and in another embodiment, the method further comprises assay or analysis of said fluid. In another embodiment, the analysis is a method of cellular analysis, which in one embodiment comprises the steps of:
c. introducing a buffered suspension comprising cells and a reagent for cellular analysis into said microfluidic chamber; and
d. analyzing at least one parameter affected by contact between said suspension and said reagent.

In another embodiment the reagent is an antibody, a nucleic acid, an enzyme, a substrate, a ligand, or a combination thereof, and in another embodiment, the reagent is coupled to a detectable marker, which in one embodiment is a fluorescent compound. In another embodiment, according to this aspect, the device is coupled to a fluorimeter or fluorescent microscope.

In another embodiment the method further comprises the step of introducing a cellular lysis agent in said port. In one embodiment, the specifically interacts or detects an intracellular compound.

In another embodiment, the assay or analysis of fluid is a method of analyte detection or assay. According to this aspect and in one embodiment, the method further comprises the steps of:
a. introducing an analyte to said device;
b. introducing a reagent to said device; and
c. detecting, analyzing, or a combination thereof, of said analyte.

In one embodiment, mixing reconstitutes a compound in the device, upon application of said fluid, and in another embodiment, the compound is solubilized slowly in fluids.

In one embodiment, mixing results in high-throughput, multi-step product formation. In one embodiment, the method further comprises the steps of:
a. introducing a precursor to the device;
b. introducing a reagent, catalyst, reactant, cofactor, or combination thereof to said device;
c. providing conditions whereby said precursor is converted to a product; and
d. optionally, collecting said product from said device.

In one embodiment the method further comprises the steps of carrying out iterative introductions of said reagent, catalyst, reactant, cofactor, or combination thereof in (b), to said device.

In another embodiment, the mixing results in drug processing and delivery. According to this aspect and in one embodiment, the method further comprises the steps of:
i. introducing a drug and a liquid comprising a buffer, a catalyst, or combination thereof to the device;
ii. providing conditions whereby said drug is processed or otherwise prepared for delivery to a subject; and
iii. collecting said drug, delivering said drug to a subject, or a combination thereof.

In another embodiment, this invention provides a method of mixing a fluid, comprising applying a fluid to a device or an apparatus of this invention.

In some embodiments, the invention provides methods, devices and apparatuses for mixing or stirring fluid in a fixed chamber, for long range pumping down a channel of a device of this invention, or a combination thereof. In some embodiments, such stirring may be applied in a multitude of applications, including any of the methods as described herein, or other applications, readily appreciated by one skilled in the art. For example, such methods, devices and apparatuses may find application in bioassays, and may, for example, impart greater speed or sensitivity to such assays. In some embodiments, such methods, devices and apparatuses may find application in the construction, probing or assay of DNA arrays, in a fixed chamber, or in another embodiment, in a microfluidic loop arrangement and may, for example, impart greater speed or sensitivity to such assays, allow for smaller sample or probe quantities for such assay, or other advantages apparent to one in the art.

In some embodiments, the terms “mixing” or “circulating” are to be understood as interchangeable. In some embodiments, “circulating” or “mixing” capabilities of the methods, devices and apparatuses of this invention may involve arrangement of the electrodes such that flow over the electrodes impinges on a wall of the channel, resulting in greater mixing.

In some embodiments, “circulating” or “mixing” capabilities of the methods, devices and to apparatuses of this invention may further promote increased diffusion of molecular species or decrease the distance over which diffusion must act, or in some emobidments, eliminate concentration variations in a fluid. Such an effect may reduce the rate of dispersion along the flow by carrying unit volumes of the fluid between fast and slow moving regions. In net effect, i.e., as the fluid progresses through the mixing apparatus, the mixing of the fluid or fluids is increased as the diffusion area is increased and, consequently, the time required to achieve mixing to a desired homogeneity is reduced.

In some embodiments, the methods, devices and apparatuses of this invention may circulate fluid in a “closed box” where fluid is injected into the device by any means known in the art and mixed therein.

In some embodiments, the term “mixing” refers to fluid in the devices/apparatuses of the invention having at least two varied trajectories, upon applying voltage to a respective series of electrodes. In some embodiments, the devices/apparatuses of the invention promote flow along at least one trajectory that effectively stirs the fluid, circulates the fluid, or a combination thereof.

In some embodiments, the invention provides devices/apparatuses/methods for circulting/mixing a fluid over a target surface with a bound reagent, or in other embodiments, circulates a fluid having a reagent that specifically fluorescently labels analytes that are bound to that surface, which may be assessed via optical means, or in some embodiments, the surface is so constructed so as to detect changes in gate voltage on a transistor structure when an analyte or reagent binds, and when binding creates electrical, conducting, or semiconducting connections between two electrodes on the surface. Such applications may find use in the methods of this invention, as described herein, and as will be appreciated by one skilled in the art.

In some embodiments, this invention provides for analysis, detection, concentration, processing, assay, production of any material in a microfluidic device, whose principle of operation comprises electro-osmotically driven fluid flow, for example, the incorporation of a source providing an electric field in a microchannel of the device, and provision of an electrokinetic means for generating fluid motion whereby interactions between the electric field and induced-charge produce electro-osmotic flows, and wherein the electric field is supplied as a function of application of voltage to a series of electrodes arranged in the device, whereby flow in the region proximal to the series is such that flow proximal to a first series has a varied trajectory from that proximal to a second series. Such flows may in turn, find application in mixing of materials, and optionally fluid conductance, and any application which makes use of these principles is to be considered as part of this invention, representing an embodiment thereof. Such flows will, in other embodiments of this invention, be enhanced as a function of the incorporation of an HSP in a particular series.

In another embodiment, the fluid comprises solutions or buffered media for use suitable for the particular application of the device, for example, with regards to the method of cellular analysis, the buffer will be appropriate for the cells being assayed. In one embodiment, the fluid may comprise a medium in which the sample material is solubilized or suspended. In one embodiment, such a fluid may comprise bodily fluids such as, in some embodiments, blood, urine, serum, lymph, saliva, anal and vaginal secretions, perspiration and semen, or in another embodiment, homogenates of solid tissues, as described, such as, for example, liver, spleen, bone marrow, lung, muscle, nervous system tissue, etc., and may be obtained from virtually any organism, including, for example mammals, rodents, bacteria, etc. In some embodiments, the solutions or buffered media may comprise environmental samples such as, for example, materials obtained from air, agricultural, water or soil sources, which are present in a fluid which can be subjected to the methods of this invention. In another embodiment, such samples may be biological warfare agent samples; research samples and may comprise, for example, glycoproteins, biotoxins, purified proteins, etc. In another embodiment, such fluids may be diluted, so as to comprise a final electrolyte concentration which ranges from between about 10 nM-0.1M.

In one embodiment, the pH, ionic strength, temperature or combination thereof of the media/solution, etc., may be varied, to affect the assay conditions, as described herein, the rate of transit through the device, mixing within the device, or combination thereof.

As will be appreciated by those in the art, virtually any experimental manipulation may have been done on the sample prior to its use in embodiments of the present invention. For example, a variety of manipulations may be performed to generate a liquid sample of sufficient quantity from a raw sample. In some embodiments, gas samples and aerosol samples are so processed to generate a liquid sample containing molecules whose separation may be accomplished according to the methods of this invention.

In some embodiments, the invention provides methods for circulating fluid in a microfluidic cavity, comprising applying the fluid to a device comprising two or more series of electrodes connected to a source wherein each electrode in each series has stepped or recessed features, which in some embodiments, produces a flow, which has a nonzero component directed toward a boundary of a channel in the device. In some embodiments, such devices and methods of their use allow for the conveyance of, inter alia, cells, analytes, antibodies, antigens, DNA, polymers, proteins in solution, and others over a desired surface, for example, a detection surface.

According to this aspect, and in some embodiments, a capture antibody, or cross-linking agent, or enzyme in solution is applied to such device, and is conducted such that these reagents come into contact with the desired surface. In some embodiments, a portion of the device optically transparent, or facilitates optical detection of a label, which may be incorporated in the agents or reagents as described herein, to facilitate detection. For example, at least a portion of the device may be transparent at a wavelength corresponding to excitation and emission for a fluorescent tag, which may be coupled to a reagent or compound in the fluids applied to the device. In some embodiments, according to this aspect, the device may be constructed to comprise non-transparent sections, to minimize or abrogate photobleaching of sensitive reagents.

In one embodiment, the surface of the microchannel may be functionalized to reduce or enhance to adsorption of species of interest to the surface of the device. In another embodiment, the surface of the microchannel has been functionalized to enhance or reduce the operation efficiency of the device.

In one embodiment, the device is further modified to contain an active agent in the microchannel, or in another embodiment, the active agent is introduced via an inlet into the device, or in another embodiment, a combination of the two is enacted. For example, and in one embodiment, the microchannel is coated with an enzyme at a region wherein molecules introduced in the inlet will be conveyed past, according to the methods of this invention. According to this aspect, the enzyme, such as, a protease, may come into contact with cellular contents, or a mixture of concentrated proteins, and digest them, which in another embodiment, allows for further assay of the digested species, for example, via introduction of a specific protease into an inlet which conveys the enzyme further downstream in the device, such that essentially digested material is then subjected to the activity of the specific protease. This is but one example, but it is apparent to one skilled in the art that any number of other reagents may be introduced, such as an antibody, nucleic acid probe, additional enzyme, substrate, etc.

In one embodiment, processed sample is conveyed to a separate analytical module. For example, in the protease digested material described hereinabove, the digestion products may, in another embodiment, be conveyed to a peptide analysis module, downstream of the device. The amino acid sequences of the digestion products may be determined and assembled to generate a sequence of the polypeptide. Prior to delivery to a peptide analysis module, the peptide may be conveyed to an interfacing module, which in turn, may perform one or more additional steps of separating, concentrating, and or focusing.

In another embodiment, the microchannel may be coated with a label, which in one embodiment is tagged, in order to identify a particular protein or peptide, or other molecule containing the recognized epitope, which may be a means of sensitive detection of a molecule in a large mixture, present at low concentration.

For example, in some embodiments, reagents may be incorporated in the buffers used in the methods and devices of this invention, to enable chemiluminescence detection. In some embodiments the method of detecting the labeled material includes, but is not limited to, optical absorbance, refractive index, fluorescence, phosphorescence, chemiluminescence, electrochemiluminescence, electrochemical detection, voltametry or conductivity. In some embodiments, detection occurs using laser-induced fluorescence, as is known in the art.

In some embodiments, the labels may include, but are not limited to, fluorescent lanthanide complexes, including those of Europium and Terbium, fluorescein, fluorescamine, rhodamine, tetramethylrhodamine, eosin, erythrosin, coumarin, methyl-coumarins, pyrene, Malacite green, stilbene, Lucifer Yellow, Cascade Blue™, Texas Red, 1,1′-[1,3-propanediylbisRdimethylimino-3,1-propanediyl]]bis[4-[(3-methyl-2(3H)-benzoxazolylidene)methyl]]-,tetraioide, which is sold under the name YOYO-1, Cy and Alexa dyes, and others described in the 9th Edition of the Molecular Probes Handbook by Richard P. Haugland, hereby expressly incorporated by reference. Labels may be added to ‘label’ the desired molecule, prior to introduction into the devices of this invention, in some embodiments, and in some embodiments the label is supplied in a microfluidic chamber. In some embodiments, the labels are attached covalently as is known in the art, or in other embodiments, via non-covalent attachment.

In some embodiments, photodiodes, confocal microscopes, CCD cameras, or photomultiplier tubes maybe used to image the labels thus incorporated, and may, in some embodiments, comprise the apparatus of the invention, representing, in some embodiments, a “lab on a chip” mechanism.

In one embodiment, detection is accomplished using laser-induced fluorescence, as known in the art. In some embodiments, the apparatus may further comprise a light source, detector, and other optical components to direct light onto the microfluidic chamber/chip and thereby collect fluorescent radiation thus emitted. The light source may comprise a laser light source, such as, in some embodiments, a laser diode, or in other embodiments, a violet or a red laser diode. In other embodiments, VCSELs, VECSELs, or diode-pumped solid state lasers may be similarly used. In some embodiments, a Brewster's angle laser induced fluorescence detector may used. In some embodiments, one or more beam steering minors may be used to direct the beam to a desired location for detection.

In one embodiment, a solution or buffered medium comprising the molecules for assay are used in the methods and for the devices of this invention. In one embodiment, such solutions or buffered media may comprise natural or synthetic compounds. In another embodiment, the solutions or buffered media may comprise supernatants or culture media, which in one embodiment, are harvested from cells, such as bacterial cultures, or in another embodiment, cultures of engineered cells, wherein in one embodiment, the cells express mutated proteins, or overexpress proteins, or other molecules of interest which may be thus applied. In another embodiment, the solutions or buffered media may comprise lysates or homogenates of cells or tissue, which in one embodiment, may be otherwise manipulated for example, wherein the lysates are subject to filtration, lipase or collagenase, etc., digestion, as will be understood by one skilled in the art. In one embodiment, such processing may be accomplished via introduction of the appropriate reagent into the device, via, coating of a specific channel, in one embodiment, or introduction via an inlet, in another embodiment.

It is to be understood that any complex mixture, comprising two or more molecules, whose assay is desired, may be used for the methods and in the devices of this invention, and represent an embodiment thereof.

In some embodiments, the term “drug processing” refers to reconstitution of a drug, altering a drug, modifying a drug, or any preparation desired to prepare a drug or composition for administration to a subject.

In some embodiments, the invention provides devices preloaded with a compound, for example a to lyophilized drug, which is packaged and distributed as such, under sterile conditions. In some embodiments, according to this aspect, a fluid is introduced into such a device, and the drug or other compound contained therewithin is reconstituted or diluted or processed, in some embodiments, just prior to delivery to a subject, or for any period of time, or for storage, etc.

Metabolic processes and other chemical processes can involve multiple steps of reactions of precursors with an enzyme, or catalyst, or mimetic, etc., in some embodiments, with or without the involvement of cofactors, in other embodiments, to obtain specific products, which in turn are reacted, to form additional products, etc., until a final desired product is obtained. In one embodiment, the devices and/or methods of this invention are used for such a purpose. In one embodiment, such methodology enables use of smaller quantitites of reagents, or precursors, which may be limiting, in other embodiments, wherein such methodology enables isolation of highly reactive intermediates, which in turn may promote greater product formation. In another embodiment, such methodology enables greater sensitivity of detection, as well, and use of lesser quantity of compound and/or reagent, due to enhanced mixing of the same. It will be apparent to one skilled in the art that a means for stepwise, isolated or controlled synthesis provides many advantages, and is amenable to any number of permutations.

It is to be understood that any of the embodiments described herein, with regards to samples, reagents and device embodiments are applicable with regard to any method as described herein, representing embodiments thereof.

In another embodiment, the modulated induced-charge electroosmotic devices of this invention circulate solutions containing probe molecules over target surfaces. In one embodiment, the probe may be any molecule, which specifically interacts with a target molecule, such as, for example, a nucleic acid, an antibody, a ligand, a receptor, etc. In another embodiment, the probe will have a moiety which can be chemically cross-linked with the desired target molecule, with reasonable specificity, as will be appreciated by one skilled in the art. According to this aspect of the invention and in one embodiment, a microchannel of the device may be coated with a mixture, lysate, sample, etc., comprising a target molecule of interest.

In one embodiment, such a device provides an advantage in terms of the time needed for assay, the higher sensitivity of detection, lower concentration of sample/reagents needed, since the sample may be recirculated over the target surface, or combination thereof.

In some embodiments, in devices for use in regulating drug delivery, the second liquid serves to dilute the drug to a desired concentration. In one embodiment, the device comprises valves, positioned to regulate fluid flow through the device, such as, for example, for regulating fluid flow through the outlet of the device, which in turn prevents depletion from the device, in one embodiment. In another embodiment, the positioning of valves provides an independent means of regulating fluid flow, apart from a relay from signals from the subject, which stimulate fluid flow through the device.

In another embodiment, this invention provides a device for use in drug delivery, wherein the device conveys fluid from a reservoir to an outlet port. In one embodiment, drug delivery according to this aspect of the invention, enables mixing of drug concentrations in the device, or altering the flow of the drug, or combination thereof, or in another embodiment, provides a means of continuous delivery. In one embodiment, such a device may be implanted in a subject, and provide drug delivery in situ. In one embodiment, such a device may be prepared so as to be suitable for transdermal drug delivery, as will be appreciated by one skilled in the art.

In another embodiment of this invention, high-slip polarizable (HSP) surfaces or materials amplify any type of induced-charge electrophoretic (ICEP) particle motion, which in some embodiments may occur at the same time as motion due to dielectrophoresis. For example, HSP particles, or HSP coated particles can be sorted by size or shape or assembled into colloidal structures by HSP-assisted ICEP in low-frequency electric fields, following the principles of ICEP motion laid out by Bazant and Squires [Physical Review Letters 92, 066101 (2004)] and Squires and Bazant [Journal of Fluid Mechanics 560, 65-101 (2006)], incorporated herein by reference in their entirety. In some embodiments, Janus particles, or other patterned HSP nanoparticles, comprising or being coated by an HSP in discrete locations on the particle, exhibit enhanced ICEP mobility of the particle, as a function of the HSP incorporation. For example, the ICEP motion of metallo-dielectric Janus particles comprising latex spheres partially coated with gold thin films has recently been reported by S Gangwal et al [arXiv:0708.2417v1] incorporated by reference in its entirety, and in one embodiment the said motion may be amplified by using an HSP surface in place of the gold coating. As is known to those skilled in the art, the uncoated, less polarizable region of a Janus particle or other irregular particle can be used for other purposes, as described in some of the references herein, such as detection or trapping of target molecules by attached functional groups or apply forces via ICEP motion of the particle to attached biological molecules or cells. HSP-assisted ICEP can also aid in self-assembling Janus particles in electric fields for the purpose of fabricating novel materials with anisotropic mechanical, electrical or optical properties.

HSP surfaces can also be incorporated into particles with complex multi-part heterogeneities. For example, in some embodiments of this invention, a cylindrical particle consisting of alternating metallic layers has at least one of its surfaces or layers filled with or coated by HSP material. Such particles can be used for labeling molecules or cells or for storing information as “nanobarcodes”, whose fabrication and use has been described in many previous patents and papers, including (but not limited to) U.S. Pat. Nos. 7,241,629, 7,225,082, 6,919,009, and 7,045,049 and US Patent Applications 20020104762, 20030119207, 20030209427, and 20040058328, which are incorporated herein by reference in their entirety. The HSP material enhances the effect of ICEP on the alignment and hydrodynamic interactions of such particles, e.g. as described by K Rose and J G Santiago [Physical Review E 75, 011503 (2007)] or D Saintillan et al [Journal of Fluid Mechanics 563, 223-259 (2006)], which may be useful in preparing said particles for optical reading or for self-assembly into complex anisotropic materials.

In one embodiment this invention provides a composite nanoparticle, wherein the nanoparticle or a portion thereof is comprised of or is coated with a high slip polarizable material. In one embodiment, only a portion of the nanoparticles incorporates an HSP, or in another embodiment, the nanoparticles incorporates the HSP in a particular pattern.

In one embodiment, a conductive bonding layer is positioned between the high slip polarizable material and the particles or portions thereof. In another embodiment, the nanoparticle further comprises a targeting moiety, a detectable marker or a combination thereof.

According to this aspect and in one embodiment, the composite nanoparticle comprises a metal. In another embodiment, the particle comprises an HSP coating around a metallic core, or in another embodiment, only a portion of the particle comprises an HSP coating.

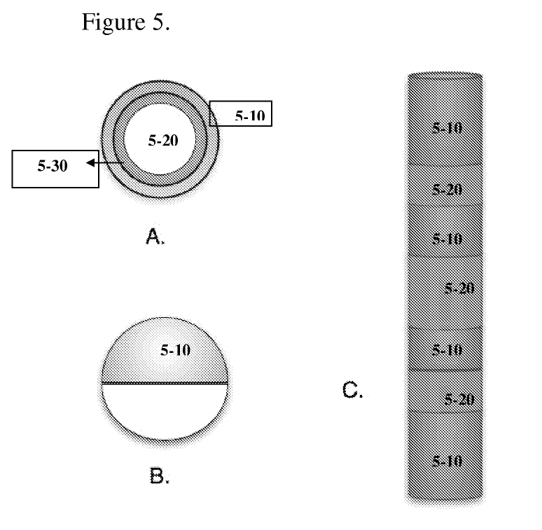

In one embodiment, the particle is spherical or in another embodiment, the particle is cylindrical. FIG. 5 exemplifies some embodiments of the composite nanoparticles of this invention, and some embodiments of different patterning of the HSP material in such nanoparticles. By the term “nanoparticle” (which could be used interchangeably with “microparticle” in some embodiments) it is to be understood that any shape, size particle from 1 nm to 100 microns in linear extent is to be considered as part of this invention, when such a particle incorporates an HSP via any method, or in any pattern, or according to any design, as will be known to one skilled in the art, and as exemplified herein.

In one embodiment, the HSP material comprises any embodiment as herein described. In some embodiments, the HSP material is carbon based, which in some embodiments contains graphite or diamond and in other embodiments is a fullerene nanoparticle or nanoparticle composite. In some embodiments, said fullerene nanoparticles may include carbon nanotubes, nanowalls, buckyballs, nanohorns, graphene platelets, etc. which may, in some embodiments, be assembled or incorporated in a matrix by any of the methods described above for carbon-based HSP surfaces and materials. In some embodiments, the HSP surface may be grown in a carbon-containing plasma from a catalyst nanoparticle, e.g. in some embodiments consisting of iron or molybdenum cores. In other embodiments, the carbon-based HSP may be adhered to a core nanoparticle composed of a polymer. In other embodiments, the carbon-based HSP may be applied to only a portion of the particle by standard methods of producing Janus particles, such as exposure to a carbon-containing gas when the particle is suspended at a gas/liquid interface. In other embodiments, HSP carbon coatings on polymer cores can be produced by analogous methods to C-MEMS, via pyrolization by heating or polymer particles.

In some embodiments, the HSP surfaces on nanoparticles have the same composition and similar fabrication methods as all the examples detailed above for HSP surfaces on microfluidic components and electrodes, including metal/polymer composites and superhydrophobic, conducting surfaces. In some embodiments, HSP nanoparticles may be fabricated by fragmenting any HSP surface or material, e.g. using mechanical or electrical forces or electrochemical or reactive-ion etching. In other embodiments, the HSP surfaces are grown on catalyst nanoparticles or assembled by attachment to reactive sites on a core nanoparticle consisting of polymer and/or metallic materials.

In other embodiments, the nanoparticles with HSP surfaces are fabricated in microfluidic devices, which in some embodiments are created using droplet-based digital microfluidic technologies, e.g. as described by J Millman et al [Nature Materials 4, 98-102 (2005)], Z Nie et al [Journal of the American Chemical Society, 127, 8058-8063 (2005); Journal of the American Chemical Society 128, 9048-9412 (2006)], M Seo et al [Soft Matter 3, 986-992 (2007)]. There are many such methods of nanoparticle synthesis, which could be adapted to yield particles with whole or partial HSP surfaces. For example, in some embodiments, said nanoparticles may wholly or partially comprise polymeric materials which are solidified in droplets of liquid containing monomers along with possible conducting additives by cooling, chemical exposure or UV radiation, and droplets pinched off from multiple parallel liquid streams may be used to make heterogeneous Janus or multilayer particles incorporating HSP surfaces.

In some embodiments, the composite nanoparticles of this invention function as nanobarcodes, which in some embodiments, refers to a particle or assembly of particles, which are useful in detecting or identifying a substance that is selective for the nanobarcode. In some embodiments, the nanobarcode may comprise one or more submicrometer metallic barcodes, carbon nanotubes, fullerenes or any other nanoscale moiety that may be detected and identified by scanning probe microscopy. In some embodiments, the nanobarcode may comprise, for example, two or more fullerenes attached to each other.

In some embodiments, the composite nanoparticles of this invention, for example, nanobarcodes may comprise an assembly of multiple HSP complex structures, for example, large and small fullerenes attached together in a specific order. The order of differently sized complex structures, may, in turn be detected by various means, for example, by scanning probe microscopy and used, for example, to identify material attached thereto, for example, the sequence of an attached oligonucleotide probe. In some embodiments, the composite nanoparticles further comprise a targeting or detection moiety.

Methods and apparatus for assembly of the composite nanoparticles, attachment /alignment of the HSP, or other incorporated moieties, such as a targeting/detection moiety, for example, nucleic acids, oligonucleotide probes and/or nanobarcodes are known in the art and are readily applied for this purpose (See, for example, U.S. Pat. Nos. 5,840,862; 6,054,327; 6,225,055; 6,248,537; 6,265,153; 6,303,296 or 6,344,319). The skilled artisan will readily appreciate how to modify such methods to prepare the composite nanoparticles of this invention.

In one embodiment, this invention provides a method of high speed electrophoresis, the method to comprising the steps of applying a composite nanoparticles of this invention to an electrophoretic device. In some embodiments, the method comprises:
applying a fluid comprising a composite nanoparticle of this invention, or a nanoparticle whose surface is comprised entirely or predominantly of HSP regions, as herein described, to an electrophoretic device; and
applying voltage to the device;
whereby the nanoparticles are conveyed through the fluid in response to application of voltage.

In one embodiment, the voltage applied is between about 1 V and 10 kV, depending on the electrophoretic separation device and method. In the case of standard gel electrophoresis, the incorporation of HSP nanoparticles may be used to alter the molecular mobilities, in devices that require large DC voltages in the range 100 V to 10 kV, in some embodiments. In other embodiments, the separation, sorting or assembly of the HSP particles or complexes is accomplished by ICEP in free solution in microchannels, which requires much smaller, typically AC, voltages, as small as one Volt applied by microelectrodes. The use of HSP surfaces enhances ICEP mobility and thus reduces the required voltage to achieve the same degree of particle manipulation.

In one embodiment, the nanoparticle further comprises a targeting moiety, a detectable marker or a combination thereof. In one embodiment, the fluid comprises a biological sample. In another embodiment, the method further comprises assay or analysis of said fluid or separation of components of said sample. In another embodiment, the analysis is a method of DNA analysis, a method of DNA separation, or a combination thereof. In another embodiment, the method comprises the steps of:
a. probing a DNA sample with said nanoparticle conjugated to an oligonucleotide of interest; and
b. subjecting said DNA sample to electrophoresis.

In some embodiments, the nanoparticle is conjugated to an antibody, a nucleic acid, an enzyme, a substrate, a ligand, or a combination thereof.

Although the present invention has been shown and described with respect to several preferred embodiments thereof, various changes, omissions and additions to the form and detail thereof, may be made therein, without departing from the spirit and scope of the invention.

### Examples

### Example 1

### Enhanced Induced-Charge Electro-Osmotic Flow in Devices with High Slip Polarizable Surfaces

It will be clear to the skilled artisan that there are many devices and methods which may apply the use of HSP surfaces to drive ICEO/ACEO fluid flows in microfluidic devices. For example, and in some embodiments, the invention can be applied to electrode surfaces for AC electro-osmotic microfluidic devices, polarizable surfaces (free or fixed-potential) for more general ICEO devices, and gate-electrode surfaces for flow-FETs. All of these types of microfluidic devices with HSP surfaces can be used for fluid pumping, sample mixing, and/or trapping suspended particles, as described in the prior art cited above.

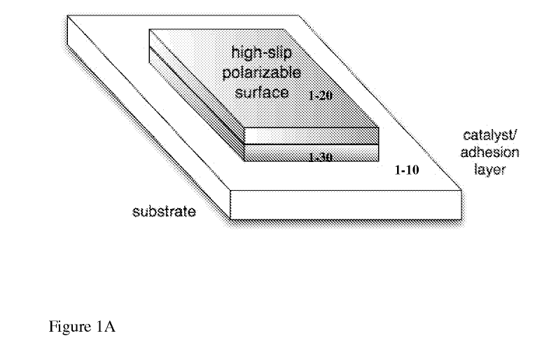

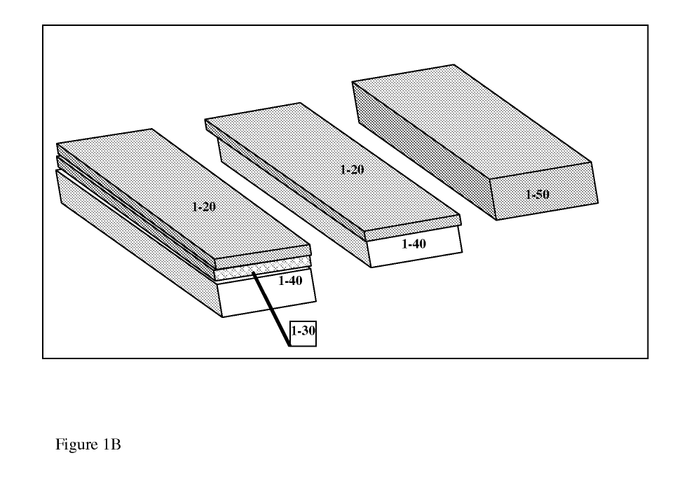

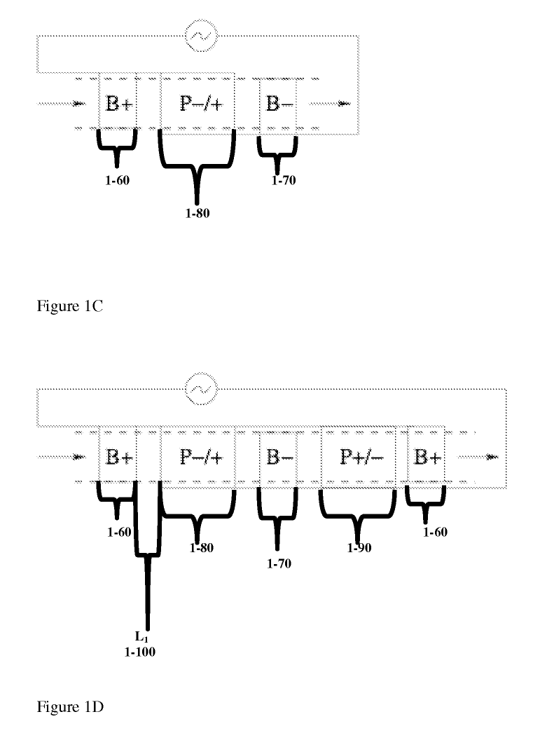

One embodiment of a device of this invention comprises a device on which at least one surface of the device, or in some embodiments, one surface of a component of the device, for example a conductor or microfluidic pump, or an electrode, comprises a high slip polarizable (HSP) material, which enhances ICEO flows (FIG. 1). As exemplified in FIG. 1, the HSP material may comprise a thin or thick surface coating (1-20) on a substrate (1-10), and optionally, an adhesion and/or catalyst layer (1-30) is positioned betwee HSP coating and an underlying substrate.

In some embodiments, the HSP layer or material comprises a homogeneous surface composed of a single chemical compound in contact with an aqueous salt solution. In some embodiments, the HSP is a hydrophobic material possessing a large slip length, for example, arising as a function of chemical interactions or the spontaneous formation of nanobubbles. In some embodiments, the HSP layer or material does not diminish the conductivity of the material onto which it is affixed, or in some embodiments, is itself a highly conductive material, which contributes to ICEO flows. In some embodiments, the HSP layer or material does not interfere with the capacitive charging of the double layer leading to ICEO flow.

In some embodiments, the HSP layer or material is comprised of carbon.

In some embodiments, the device in which an HSP layer or material is incorporated is a fixed-potential ICEO device comprising pumps such as that described by [Squires & Bazant Physical Review Letters 92, 066101 (2004)], or United States Patent Application Publication No. 2003016429, filed 2003, fully incorporated by reference herein. According to this aspect and in some embodiments, the pumps comprise the HSP layer or material.

In some embodiments, the device in which an HSP layer or material is incorporated is an ICEO device comprising micromixers such as that described Levitan et al., in U.S. patent application Ser. No. 11/252,871, filed on Oct. 19, 2005 or nonlinear AC Flow-FET devices such as those described in Schasfoort et al. [Science 286, 942 (1999)], fully incorporated by reference herein. According to this aspect and in some embodiments, the micromixers comprise the HSP layer or material.

In some embodiments, devices utilizing electroosmotic flow for their operation comprising 3D ACEO micropumps or, in some embodiments, ICEO columnar posts, may comprise carbon electrodes, deposited on, for example, a patterned substrate, e.g. made of etched glass or polymer, fabricated for example by known methods such as those described in Levitan et al., in U.S. patent application Ser. No. 11/252,871.

It will be understood that the preparation of such devices are straightforward and may be accomplished as described in the references cited herein, or via any means known to those skilled in the art. Incorporation of a high slip polarizable material in the devices may be readily accomplished by methods described hereinabove.

In one embodiment, the carbon is in the form of crystalline, polycrystalline, or amorphous graphite. In some embodiments, the entire polarizable structure, electrode, pump, mixer, etc., driving ICEO flow may be composed of graphite, or comprise a graphite coating on a metallic adhesion/catalyst layer, similar to the model depicted in FIG. 1.

In some embodiments, the carbon coating comprises an atomically thin graphene sheet. In some embodiments, the graphene sheet incorporated in the coating as described herein, is both highly polarizable and highly hydrophobic with slip lengths on the order of tens of nanometers inferred from experiments and molecular dynamics simulations. In some embodiments amorphous or polycrystalline graphite may be incorporated as herein described within devices for use in ICEO. Although it is desirable to expose large regions of single graphitic planes at the surface, this effect may be offset by the tendency to form nanobubbles (further enhancing the effective slip length) due to surface roughness in more heterogeneous structures, representing embodiments of applications of such material to devices and methods as described herein.

Any number of permutations can be envisioned for electrodes/micropumps, etc. comprising a surface having at least a layer or comprised of an HSP, for example, as depicted in FIG. 1B. FIG. 1B schematically depicts an electrode comprising a conducting material, e.g. a metal electrode (1-40), onto which a carbon coating, or grapheme sheet has been applied (1-20). In some embodiments, the carbon is adhered to the electrode surface via a bonding layer (1-30). In some embodiments, the electrode is entirely comprised of carbon (1-50). Such examples are well suited to any of the devices as described herein.

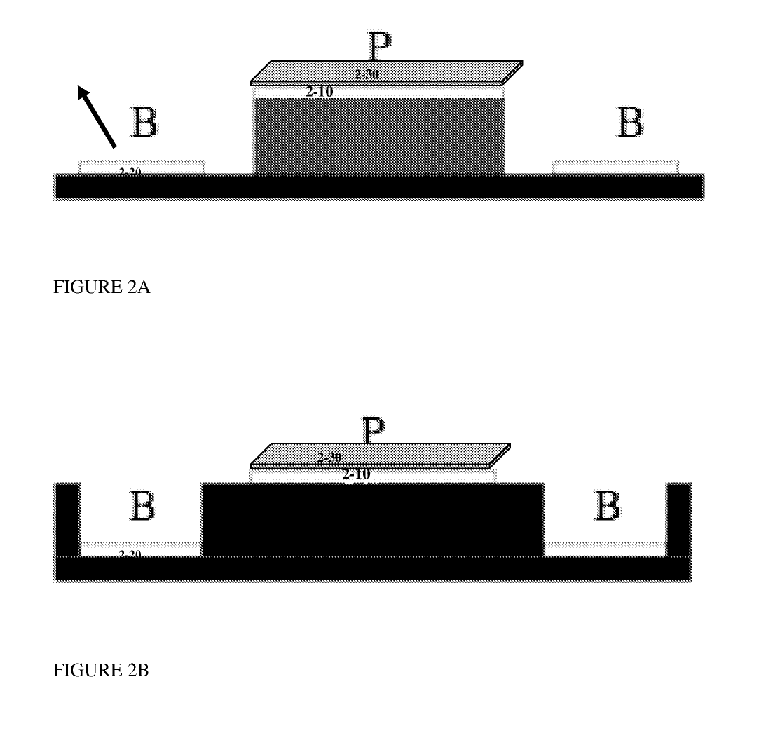

In another embodiment, an ACEO device such as that disclosed in U.S. patent application Ser. No. 11/700,949 (fully incorporated herein by reference), which may incorporate an HSP material as herein described, is depicted in FIG. 2A-2B. According to this aspect, and in one embodiment, the pumping elements (2-10) are raised in the channel or, in another embodiment, the background electrodes (2-20) are lowered into the substrate as shown in FIGS. 2A and 2B, respectively. Raised electrodes are easily fabricated and have the added advantage of confining the background electric field closer to the ceiling of the microchannel, thus further increasing the flow rate. Coating the pumping elements and/or the background electrodes with an HSP (2-30), or in some embodiments, fabricating the same from an HSP, results in faster flow rates, as compared to non-coated pumping elements, or devices with such elements which do not incorporate an HSP, as described herein, resulting in flow rates which may be enhanced by several orders of magnitude, in some embodiments. In some embodiments, pumping elements associated with flow in a desired direction are coated or comprised of an HSP, whereas elements, which result in flow counter to the desired direction are not coated or comprised of an HSP, thereby enhancing the rate of flow in the desired direction.

In some embodiments, devices of this invention incorporate an HSP layer or material, and such devices may comprise an ACEO device as shown in FIG. 2C, comprising micropumps, such as that described by Ramos [Journal of Colloid and Interface Science 217, 420-422 (1999)] or Brown [Physical Review E 63, 016305 (2001)] or US Patent Application Publication No. 20050040035, or World International Property Organization PCT International Patent Application PCT/GB03/00082 filed July 2004, fully incorporated by reference herein. According to this aspect and in some embodiments, the micropumps comprise the HSP layer or material.

In another embodiment, an ICEO device, exemplifying the 3D ACEO devices disclosed in U.S. patent application Ser. No. 11/700,949 (fully incorporated herein by reference), which may incorporate an HSP material as herein described, is depicted in FIG. 2D. According to this aspect and in one embodiment, the device comprises periodic pairs of symmetric electrodes by either (i) lowering the portions of the electrodes that pump in the undesired direction or (ii) raising the portions of the electrodes that pump in the desired direction, e.g., in this aspect, the left half of each electrode in the pair is raised by half of the electrode width. The resulting asymmetric pair of stepped, multilevel electrodes takes advantage of the conveyor-belt effect to achieve a fast pumping flow driven by the raised portions, streaming over reverse convection rolls driven by the lower positions. According to this aspect of the invention, the device embodied hereto increases flow, as a function of minimizing alignment of opposing slip regions, as well as incorporating a high slip polarizable material on the electrode surfaces.

In another embodiment of 3D ACEO devices, the aforementioned electrode array has insulating or dielectric sidewalls on each of the raised steps, as shown in FIG. 2E. This feature may enhance the flow rate by another factor of two, versus the design of FIG. 2D and to extend the operating range to higher frequency without flow reversal. In this invention, the new feature is that the electrodes comprise HSP surfaces.

In the standard low-voltage model, ACEO flow scales as u˜εV²/ηL, where ε is the permittivity, η the viscosity, L the electrode length scale, and V the applied voltage. For typical experimental conditions (L=5 μm, V=2 V) in aqueous solutions (λ=5 nm, D=0.5×10⁻⁵ cm²s⁻¹, ε=7×10⁻⁵ g cm V⁻²s⁻², η=0.01 g cm⁻¹s⁻¹), theoretical simulations by Bazant and Ben [Lab on a Chip (2006)] predict that the stepped pump in FIG. 2D has a mean velocity νₘₐₓ=760 μm s⁻¹ and frequency ωₘₐₓ=20 kHz at the maximum flow rate, while a planar pump has almost the same peak frequency, but a much smaller velocity νₘₐₓ=44 μm s⁻¹, assuming a surface with no hydrodynamic slip.

If, as in this invention, the electrodes comprise an HSP material with slip length b and surface capacitance per unit area Cₛ=C_{d}/δ=ε/λδ (accounting for the surface layer between the liquid and the to position of the applied voltage), then the fluid velocity is multiplied by the factor (1+b/λ)/(1+δ) and the peak frequency by the factor (1+δ). The capacitance of a highly polarizable surface Cₛ is very large compared to that of the diffuse part of the double layer C_{d} and thus ideally δ<<1. To allow for the HSP surface to not be a perfect conductor, we may estimate δ=0.5, and for the high slip length of the HSP surface, we may estimate b=50 nm. In this example, the use of the HSP surfaces amplifies the velocity by 11*(⅔)=7.3 and multiplies the peak frequency by 3/2. The resulting mean pumping velocities with the HSP surfaces of this invention would be much faster, 5 5 mm/sec for the 3D ACEO pump and 320 μm/sec for the planar pump, at a peak frequency of 30 kHz.

### Example 2

### Embodiments of ICEO Devices with HSP Surfaces

In another embodiment, ICEO devices, such as those described in Example 1, comprise HSP surfaces which contain carbon nanostructures, such as nanotubes (CNT), which can be single-walled or multi-walled, or in some embodiments, in the form of other fullerene structures, such as, and in some embodiments, nanohorns, nanobuds, buckyballs, or fullerite. The surfaces of such nanostructures resemble curved graphene sheets and are typically hydrophobic.

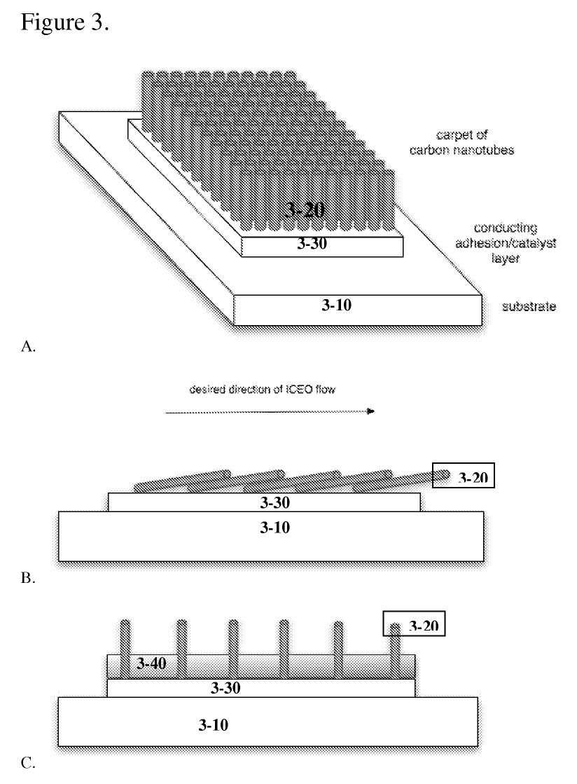

According to this aspect of the invention, and in some embodiments, the complex structures, as for the coating, display significant slip lengths. For example, metallic single-wall CNT have been reported to have very large slip lengths (up to 100 nm outside, up to 1 micron inside). Double-wall CNT retain similar properties but are more resistant to damage from impurity adsorption. The hydrodynamic slip length on the outer side of a CNT is typically much larger in the direction parallel to the cylindrical axis, so in some embodiments of this invention, the devices/methods of this invention make use of electrodes/pumping elements (3-10) comprising nanotubes (3-20) aligned as a carpet or forest on the surface of the electrodes/pumping elements in an orientation parallel to the desired direction of ICEO flow, to promote faster flows (FIG. 3). The nanotubes may be adhered to a substrate (3-30), via a bonding layer (3-10). In some embodiments, where chaotic mixing is desirable, such nanotube or complex structure associated electrodes/pumping elements will be aligned perpendicular or in other non-parallel orientation to the direction of dominant flow.

There are many possible methods for fabricating carbon microstructures, particles, or coatings. For example, carbon nanotubes and other fullerenes can be grown on a graphite electrode by passing a large current. Another process, which is more suitable for microfabrication and mass production of ICEO microfluidic devices, is chemical vapor deposition (CVD). In this fabrication method, a layer of metal catalyst (e.g. consisting of Fe, Ni, or Co particles) is deposited in desired locations on the substrate and exposed to a to plasma containing a process gas, such as H or N, and a carbon-containing gas, such as acetylene or methane, heated to 700-850 degrees Celsius. In the case where CNT are grown from catalyst particles, the CNT can be aligned by application of electric fields or by lateral gas flow of the plasma. The substrate material must be chosen to remain stable and solid at the high temperature used in CVD, which rules out many polymers used in soft lithography fabrication, but allows most standard materials used in micro-fabrication, such as silicon and high-temperature glasses.

For differences in orientation of the HSP complex structures, different processes of device preparation may be utilized. For example, in FIG. 3A, where the electrode/substrate/bonding layer is coated with a relatively uniform CNT carpet, the process may entail growing these structures on the surface by CVD on a metal catalyst layer, e.g. a dense carpet of vertical CNT grown on a surface densely covered with catalyst in ambient (no-flow) conditions. It will be apparent to one skilled in the art that the array is ordered or disordered.

When an alternative orientation for the long axis of the CNT is desired, it is possible to grow the CNT tilted in a gas flow (for example as depicted in FIG. 3B), which produces a dense carpet of tilted CNT, oriented in the direction of desired ICEO flow over the surface. Similarly, FIG. 3C shows a carpet of vertical CNT that are less densely spaced, either due to more sparse catalyst particles in the upper metal adhesion layer and/or a deposition of a filler material.

In some embodiments, the spacing of the CNT should not be much larger than the thickness of the diffuse layer in the desired electrolyte solution, as described further hereinbelow. In some embodiments, the filler material is hydrophobic so as to promote the formation of nanobubbles filling the gaps between the CNT to enhance the effective slip length of the surface. In some embodiments, the filler material is not deposited over the CNT tips and in some embodiments, terminates below (as shown) to allow nanobubbles to be recessed and the liquid free surface to stretch from CNT tip to CNT tip. This can be accomplished by controlling the growth rate through the partial pressure of filler molecules in the gas or the time of a subsequent deposition step.

Ultrahydrophobic surfaces with rough nanostructures often achieve very high slip lengths by the formation of nanobubbles, but these could be destroyed by the application of hydrodynamic or electrostatic pressure, such as would occur during surface polarization in an ICEO device. Capillary pressures of order 1 atm have been achieved with CNT forests with hydrodynamic slips of order several microns by P Joseph et al [Physical Review Letters 97, 156104 (2006)], thus, in some embodiments of this invention, the incorporation of CNT structures in the ICEO devices as herein described are useful in the methods of this invention.

### Example 3

### ICED Devices Comprising HSP Patterned Surfaces

In pressure-driven flows, effective slip can be enhanced over a patterned surface by incorporating non-wetting or liquid-phobic regions of high interfacial tension between the solid and liquid, as described above, and/or by structures promoting the formation of micro/nano-bubbles. The former is one mechanism to achieve enhanced molecular-level slip, as described above in the case of carbon. The latter can nucleate gas bubbles at surface cracks or engineered patterns of peaks and valleys, such that the fluid de-wets and forms a liquid-gas interface stretching over the valleys from peak to peak. According to this aspect and in some embodiments, high gas saturation is needed in the liquid. In some embodiments, the liquid-gas interface over a bubble is a zero stress boundary, which reduces the overall hydrodynamic resistance of the surface.

In some embodiments, this invention is directed to the use of, and devices incorporating a rough/stepped surface driving ICEO flow, having enhanced effective slip. In some embodiments, recessed regions give less hydrodynamic resistance to lateral flows generated at raised regions, which can enhance the effective slip length for the surface, compared to having no-slip regions at the same level. This is similar to the fluid-conveyor-belt concept, which has been demonstrated experimentally in 3D ACEO pumps with non-planar electrodes, but operates at the smaller scale of roughness in a single electrode surface.

In some embodiments, the devices/electrodes/substrates of this invention comprise a region with a high-slip material, wherein the region is large and completely covers the electrode/substrate surface. In preferred embodiments, the high-slip material is highly polarizable, such that the material does not interfere with double-layer charging and ICEO flow.

In some embodiments, this invention comprises devices/methods, which make use of a net enhancement of ICEO flow, even incorporating devices/electrodes/substrates with less polarizable regions, where greater effective hydrodynamic slip occurs if the characteristic horizontal length scale of such regions is smaller than the interfacial thickness λ of the diffuse part of the double layer. According to this aspect and in one embodiment, the diffuse charge induced in solution by charging of the polarizable regions of the surface extends over the regions of large hydrodynamic slip, where it leads to faster ICEO flow.

One explanation for the above, and representing one embodiment of the mechanism/design of devices/methods of this invention, considers the limit of thick double layers, which are much larger than the variations in hydrodynamic slip and polarizability on the surface. As in the continuum limit itself (which averages over molecular-scale fluctuations), such a thick double layer will be characterized by an effective, reduced polarizability of the compact-layer (or Stem layer) on the surface and by an effective, increased hydrodynamic slip length, b.

The standard model of ICEO flow, also mentioned above, predicts a net enhancement by

$$( 1 + \frac{b}{λ} ) / ( 1 + \frac{{λ}_{s}}{λ} ) ,$$

where λₛ/λ=δ is the ratio of diffuse-layer to compact-layer capacitances, expressed in terms of an effective compact-layer thickness λ_{S}. This parameter is increased as the net surface polarizability to decreases by the addition of less polarizable regions of larger slip length, compared to the case of a homogeneous polarizable surface. If b>λ_{S}, the calculation predicts that a net enhancement of ICEO flow is possible over the patterned surface.

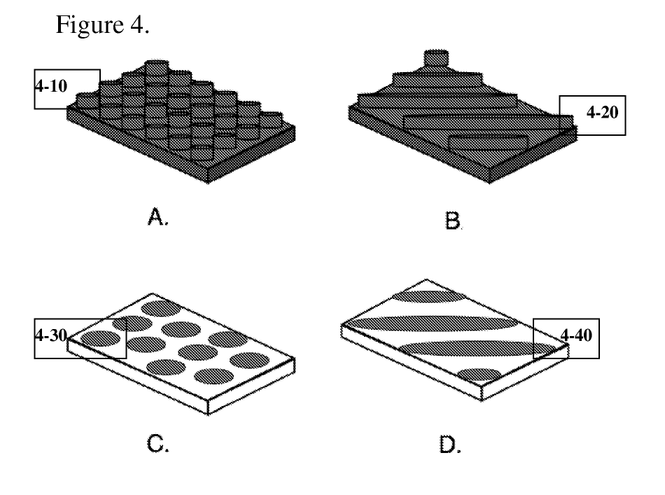

FIG. 4 shows an embodied device according to this aspect of the invention. The device comprises surfaces with raised and lowered patterns, such as islands (FIG. 4A) or grooves (FIG. 4B). The patterns are drawn as regular arrays, and in some embodiments, such devices may comprise disordered patterns or naturally rough surfaces serving a similar purpose. In some embodiments, the raised portions should be composed of a highly polarizable material to drive fast local ICEO flow and are preferred not to have lateral spacing larger than the diffuse-layer thickness in the liquid. In some embodiments, the lowered portions could be made of the same material, and a net enhancment of ICEO flow may be observed due to lowered hydrodynamic resistance over the lowered regions. In other embodiments, the lowered regions or substrate layer may also be composed of a different material, which is hydrophobic to enhance the formation of nanobubbles in the lowered cavities or grooves, similar to FIG. 3C.

In other embodiments, the surface is flat with patterned regions of at least two different materials, one polarizable (where ICEO flow is primarily generated) but of low slip length, and the other less polarizable and of greater slip length. In some embodiments, polarizable islands (FIG. 4C) or stripes (FIG. 4D) are distributed on the surface with preferred spacing not much larger than the diffuse-layer thickness.

In other embodiments, the devices of this invention comprise asymmetric patterns, such as the homogeneous grooves in FIG. 4B or the heterogeneous stripes in FIG. 4D, which in turn may also have the additional use of shaping ICEO flow over a surface, in an analogous way that grooves oriented transverse to a pressure-driven flow can cause secondary transverse circulation. According to this aspect of the invention, the mechanism for redirection is different because ICEO flow is surface-driven and occurs non-uniformly in space and time, preferentially on the raised surfaces due to larger polarization in an applied electric field. The deflection of the flow from the upper surfaces occurs by reducing hydrodynamic resistance in a preferred direction from the lowered.

### Example 4

### Enhanced Induced-Charge Electrophoresis of HSP Particles

In some embodiments of this invention, devices and/or methods of this invention comprise/make use of high-slip polarizable (HSP) surfaces to amplify induced-charge electrophoretic (ICEP) particle motion. The same flow amplification factors for various examples ICEO flow over HSP surfaces described above would describe the associated amplification of ICEP motion of particles comprising said surfaces.

In some embodiments of this invention, devices and/or methods of this invention comprise/make or can be applied to any colloidal particles, vesicles, droplets or molecules suspended in the liquids described above to enhance ICEP translation and rotation in an applied electric field (as well as dielectrophoretic motion of the same particles, as will be appreciated by one skilled in the art). For example, FIG. 5A shows an embodiment of a particle of this invention. In some embodiments, such a particle is spherical and comprises an HSP surface coating around a metallic core. Such particles can be sorted by size or shape or assembled into colloidal structures by HSP-assisted ICEP in low-frequency electric fields.

In another embodiment of this invention (FIG. 5B) a spherical Janus particle comprises a non-contiguous or partial coating, for example as shown in the figure, wherein only a portion (e.g. one hemisphere) of the particle is coated by the HSP material. The HSP hemisphere enhances the ICEP mobility of the particle, compared to the case of a non-HSP metallic surface. As is known to those skilled in the art, the uncoated region can be used for other purposes, such as detection or trapping of target molecules by attached functional groups or the application forces to attached biological molecules or cells via ICEP motion of the particle. HSP-assisted ICEP can also aid in self-assembling Janus particles (or other heterogeneous particles) in electric fields for the purpose of fabricating novel materials with anisotropic mechanical, electrical or optical properties.

In another embodiment of this invention (FIG. 5C) a cylindrical particle comprising patterned deposition of an HSP is provided. In some embodiments, for example as schematically depicted in the Figure, alternating metallic layers are patterned on the particle surface, at least one of which has a surface or layer filled with HSP material. Such particles can be used for labeling molecules or cells or for storing information (for example for use as nanobarcodes). The HSP material would serve to enhance their alignment by ICEP (and dielectrophoresis) in an electric field in preparation for optical reading of the barcoded information, compared the case of existing nanobarcode particles made of non-HSP materials (for example Au and Ag).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A device comprising at least one microfluidic chamber for pumping an electrolyte or ionic fluid, mixing an electrolyte or ionic fluid or a combination thereof, said chamber comprising:
a plurality of structures driving non-linear electroosmotic flow proximal to, positioned on, or comprising at least one surface of said chamber;
wherein at least a first portion of said structures is polarizable or comprises a first material which is polarizable and at least a second portion of said structures comprises a second material, which promotes hydrodynamic slip at a region proximal to said second portion;
connectors operationally connecting said electrodes to at least one voltage source;
whereby upon introduction of an electrolyte or ionic fluid in said device and application of said voltage, an electric field is generated in said chamber, hydrodynamic slip of a length larger than the molecular scale of the fluid is generated and nonlinear electroosmotic flow is produced in said chamber.

2. The device of claim 1, whereby said plurality of structures are arranged so as to produce:
nonlinear electro-osmotic flows with at least one varied trajectory in a region of said chamber, resulting in mixing of said electrolyte fluid;
a dominant nonlinear electroosmotic flow which drives said fluid across said chamber;
or a combination thereof.

3. The device of claim 1, wherein said plurality of structures comprise electrodes, conductor elements or a combination thereof.

4. The device of claim 3, wherein at least one conductor element is placed in an orientation that is perpendicular to the axis of said electric field, at a location within or proximal to said chamber.

5. The device of claim 3, comprising:
at least two background electrodes connected to said source, providing said electric field in said chamber; and
at least one pumping element comprising two or more parallel-positioned or interdigitated electrodes positioned therebetween; wherein electrodes in said pumping element vary in height with respect to each other, said background electrodes, or a combination thereof.

6. The device of claim 5, wherein said pumping element is held at a fixed potential, relative to that of said background electrodes.

7. The device of claim 5, wherein at least one electrode in said pumping element is grounded to one of said background electrodes.

8. The device of claim 5, wherein each electrode in said pumping element nearest to the background electrode connected to said source will have an opposite polarity as compared to said background electrode.

9. The device of claim 5, wherein an electrode in said pumping element is connected to the background electrode connected to said source, which is of the same polarity.

10. The device of claim 5, wherein electrodes in said pumping element are arranged asymmetrically with respect to a central axis in said pumping element.

11. The device of claim 3, wherein at least two of said plurality of electrodes or portions thereof are varied in height by at least 1%.

12. The device of 11, wherein said plurality of electrodes comprises at least one electrode, or a portion thereof, which is raised with respect to another electrode, or another portion of said at least one electrode.

13. The device of 11, wherein said plurality of electrodes comprises at least one electrode, or a portion thereof, which is lowered with respect to another electrode, or another portion of said at least one electrode.

14. The device of 11, wherein said plurality of electrodes comprises at least one electrode or at least a portion thereof having a height or depth, which is varied proportionally to a width of another electrode, another portion of said at least one electrode, or a combination thereof.

15. The device of claim 11, wherein said plurality of electrodes comprises at least one electrode, or portions thereof, having height or depth variations from about 1% to about 1000% of:
a width of another electrode, another portion of said at least one electrode, or a combination thereof;
a gap between said at least one electrode and another electrode;
or a combination thereof.

15. The device of claim 11, wherein at least one electrode is not flat.

16. The device of claim 11, wherein said electrodes are not co-axial, with respect to each other, in any dimension.

17. The device of claim 11, wherein positioning of said electrodes in said chamber is varied with respect to gaps between said electrodes, spacing of said electrodes, or a combination thereof.

18. The device of claim 17, wherein said gaps between said electrodes, said spacing of said electrodes, height of said electrodes or portions thereof, shapes or said electrodes or portions thereof, or a combination thereof is unequal.

19. The device of claim 3, wherein application of said voltage is to a portion of said plurality of electrodes, as a function of time.

20. The device of claim 19, where in said electrodes to which said voltage is applied comprise a first series and said electrodes to which said voltage is not applied comprise a second series.

21. The device of claim 20, wherein said first series is so positioned such that an electroosmotic flow trajectory created thereby is parallel to a long axis of said device and said second series is so positioned such that an electroosmotic flow trajectory created thereby has a component perpendicular thereto, or vice versa.

22. The device of claim 20, wherein said first series comprises said first plurality and said second series comprises said second plurality.

23. The device of claim 20, wherein said first and second series are positioned on opposing surfaces of said chamber.

24. The device of claim 19, wherein said source modulates the magnitude or frequency of the voltages applied to said series of electrodes.

25. The device of claim 24, wherein the magnitude or direction of electroosmotic flow is changed thereby.

26. The device of claim 25, wherein said changed electroosomotic flow is slower than electroosmotic flow in said chamber prior to modulation of said magnitude or frequency.

27. The device of claim 1, wherein said voltage source is a DC voltage source.

28. The device of claim 1, wherein said voltage source is an AC or pulsed AC voltage source.

29. The device of claim 1, wherein said voltage source is an AC or pulsed AC voltage source with a DC offset.

30. The device of claim 1, wherein said voltage source applies a peak to peak AC voltage of between about 0.1 and about 10 Volts.

31. The device of claim 30, wherein said AC frequency is between about 1 Hz and about 100 kHz.

32. The device of claim 1, wherein said first portion and said second portion are comprised of the same material.

33. The device of claim 1, wherein said first portion, said second portion or a combination thereof is comprised of a carbon-based material.

34. The device of claim 33, wherein said carbon-based material is crystalline, polycrystalline or amorphous graphite.

35. The device of claim 33, wherein said carbon-based material is in the form of a coating or surface layer

36. The device of claim 35, wherein said coating is an atomically thin graphene sheet.

37. The device of claim 33, wherein said carbon-based material comprises a fullerene nanostructure.

38. The device of claim 37, wherein said fullerene nanostructure comprises a nanotube, nanoplatelet, nanowall, nanohorn, nanobud, buckyball, or a combination thereof.

39. The device of claim 1, wherein said first portion comprises a metal, metal alloy or a conducting-polymer.

40. The device of claim 1, wherein said metal or metal alloy comprises gold, platinum, titanium, copper, zinc or aluminum.

41. The device of claim 1, wherein said second portion comprises a non-wetting or poorly wetting material for said fluid.

42. The device of claim 41, wherein said second portion is hydrophobic or superhydrophobic.

43. The device of claim 1, wherein said first portion, said second portion or a combination thereof refers to a portion of the total number of such structures, a portion of each of said structures or a combination thereof.

44. The device of claim 43, wherein said second portion comprises a carbon-based or hydrophobic material adhered to said structures or portions thereof.

45. The device of claim 44, wherein a conductive bonding layer is positioned between said second portion and said structures or portions thereof.

46. An apparatus comprising the device of claim 1.

47. A method of circulating or conducting a fluid, said method comprising the steps of:
applying an electrolyte or ionic fluid comprising to the device of claim 1;
applying voltage to at least a portion of said structures; and
inducing an electric field in said chamber;
whereby nonlinear electroosmotic flow is induced in said chamber, thereby being a method of circulating or conducting a fluid.

48. A method of mixing a fluid, said method comprising the steps of:
applying an electrolyte or ionic fluid to the device of claim 1;
applying voltage to at least a portion of said structures; and
inducing an electric field in said chamber;
whereby nonlinear electroosmotic flow is induced in said chamber, thereby being a method of mixing a fluid.

49. The method of claim 48, wherein said structures are arranged in at least two series, with each series varying in terms of an electroosmotic flow trajectory created by said series upon application of voltage thereto, from at least a series proximally located thereto on said at least one surface.

50. The method of claim 49, wherein said source applies voltage selectively to said series such that said voltage is not simultaneously or commensurately applied to all series of structures whereby upon selective application of said voltage to said series, electro-osmotic flows with varied trajectories are generated in a region proximal to each of said series, resulting in chaotic mixing of said fluid.

51. The method of claim 49, wherein said at least two series are positioned such that an electroosmotic flow trajectory created by a first series is in a direction opposite to an electroosmotic flow trajectory created by a second series of said at least two series.

52. The method of claim 49, wherein said first series is so positioned such that an electroosmotic flow trajectory created thereby is parallel to a long axis of said device and said second series is so positioned such that an electroosmotic flow trajectory created thereby is perpendicular thereto, or vice versa.

53. The method of claim 49, wherein the magnitude or frequency of the voltages applied to said series of structures is modulated.

54. The method of claim 53, wherein modulating said magnitude or frequency of voltages applied is via a smooth transition.

55. The method of claim 48, wherein multiple fluids may be introduced into said chamber such that said method is useful for mixing multiple fluids.

56. The method of claim 48, wherein said method further comprises assay or analysis of said fluid.

57. The method of claim 56, wherein said analysis is a method of cellular analysis.

58. The method of claim 57, wherein said method comprises the steps of:
a. introducing a buffered suspension comprising cells and a reagent for cellular analysis into said microfluidic chamber; and
b. analyzing at least one parameter affected by contact between said suspension and said reagent.

59. The method of claim 58, wherein said reagent is an antibody, a nucleic acid, an enzyme, a substrate, a ligand, or a combination thereof.

60. The method of claim 58, wherein said reagent is coupled to a detectable marker.

61. The method of claim 60, wherein said marker is a fluorescent compound.

62. The method of claim 61, wherein said device is coupled to a fluorimeter or fluorescent microscope.

63. The method of claim 88, further comprising the step of introducing a cellular lysis agent in said device.

64. The method of claim 63, wherein said reagent specifically interacts or detects an intracellular compound.

65. The method of claim 48, wherein said assay or analysis of said fluid is a method of analyte detection or assay.

66. The method of claim 65, further comprising the steps of:
a. introducing an analyte to said device;
b. introducing a reagent to said device; and
c. detecting, analyzing, or a combination thereof, of said analyte.

67. The method of claim 48, wherein said mixing reconstitutes a compound in said device, upon application of said fluid.

68. The method of claim 67, wherein said compound is solubilized slowly in fluids.

69. The method of claim 48, wherein said mixing results in high-throughput, multi-step product formation.

70. The method of claim 69, further comprising the steps of:
a. introducing a precursor to the device;
b. introducing a reagent, catalyst, reactant, cofactor, or combination thereof to said device;
c. providing conditions whereby said precursor is converted to a product; and
d. optionally, collecting said product from said device.

71. The method of claim 70, further comprising carrying out iterative introductions of said reagent, catalyst, reactant, cofactor, or combination thereof in (b), to said device.

72. The method of claim 70, wherein said reagent is an antibody, a nucleic acid, an enzyme, a substrate, a ligand, a reactant or a combination thereof.

73. The method of claim 48, wherein said mixing results in drug processing and delivery.

74. The method of claim 73, wherein said method further comprises the steps of:
i. introducing a drug and a liquid comprising a buffer, a catalyst, or combination thereof to the device;
ii. providing conditions whereby said drug is processed or otherwise prepared for delivery to a subject; and
iii. collecting said drug, delivering said drug to a subject, or a combination thereof.

75. The method of claim 74, further comprising carrying out iterative introductions of said liquid to said device.

76. The method of claim 74, wherein introduction of said liquid serves to dilute said drug to a desired concentration.

77. A composite particle, wherein a portion of said particle is comprised of a polarizable material, further comprising or coated with a second material, which when said composite particle is suspended in a fluid and subjected to nonlinear electrophoresis, at least a portion of said particle's surface exhibits a hydrodynamic slip of a length larger than the molecular scale of said fluid.

78. The composite particle of claim 77, wherein said composite particle comprises a metal.

79. The composite particle of claim 77, wherein said particle is spherical or cylindrical.

80. The composite particle of claim 77, wherein particle is sized from about 1 nanometer to about 10 micrometers.

81. The composite particle of claim 77, wherein said particle comprises a carbon-based material.

82. The composition particle of claim 81, wherein said particle comprises at least a partial carbon coating around a metallic core.

83. The composite nanoparticle of claim 81, wherein said carbon-based material is crystalline or amorphous graphite.

84. The composite nanoparticle of claim 81, wherein said carbon-based material comprises a nanotube, nanohom, nanobud, buckyball, fullerene, or a combination thereof.

85. The composite particle of claim 77, wherein a conductive bonding layer is positioned between said polarizable material and said second material.

86. The composite particle of claim 77, wherein said particle further comprises a targeting moiety, a detectable marker or a combination thereof.

87. A method of high-speed nonlinear electrophoresis, said method comprising the steps of:
applying a fluid comprising the composite particle of claim 77 to an electrophoretic device; and
applying voltage to said device;
whereby said composite particles and any material attached thereto are differentially conveyed through said fluid in response to application of said voltage.

88. The method of claim 87, wherein said voltage is in the range 1 V to 10 kV and applied at electrodes separated by 1mm or more in a standard electrophoretic device.

89. The method of claim 87, wherein said voltage is in the range 0.1 V to 10 V and applied at electrodes in a microfluidic device separated by less than 1mm

90. The method of claim 87, wherein said particle further comprises a targeting moiety, a detectable marker or a combination thereof.

91. The method of claim 87, wherein said fluid comprises a biological sample.

92. The method of claim 87, wherein said method further comprises assay or analysis of said fluid or separation of components of said sample.

93. The method of claim 92, wherein said analysis is a method of DNA analysis, a method of DNA separation, or a combination thereof.

94. The method of claim 93, wherein said method comprises the steps of:
a. probing a DNA sample with said nanoparticle conjugated to an oligonucleotide of interest; and
b. subjecting said DNA sample to nonlinear electrophoresis.

95. The method of claim 87, wherein said nanoparticles is conjugated to an antibody, a nucleic acid, an enzyme, a substrate, a ligand, or a combination thereof.

96. A method of circulating, conducting, or mixing a fluid, said method comprising the steps of:
applying an ionic liquid to a microfluidic device which is capable of inducing electro-osmotic flow
applying voltage to electrodes in said device; and
inducing an electric field in said device;
whereby electroosmotic flow is induced in said device, thereby being a method of circulating, conducting, or mixing a fluid.

97. The method of claim 96, wherein said ionic liquid is a room-temperature liquid salt.

98. The method of claim 96, wherein said ionic liquid is a hydrophobic liquid salt.
